(19) United States
(12) Patent Application Publication
(10) Pub. No.: US 2026/0088844 A1
(43) Pub. Date: Mar. 26, 2026

(54) METHOD AND APPARATUS FOR A RECONFIGURABLE SUBARRAY ARCHITECTURE (RSA) AND OBTAINING CHANNEL STATE INFORMATION (CSI) IN A WIRELESS COMMUNICATION SYSTEM

(71) Applicant: Samsung Electronics Co., Ltd., Suwon-si (KR)

(72) Inventors: Dmitry Sergeyevich DIKAREV, Moscow (RU); Alexei Vladimirovich DAVYDOV, Moscow (RU); Gregory Vladimirovich MOROZOV, Moscow (RU); Gregory Aleksandrovich ERMOLAEV, Moscow (RU); Denis Viktorovich ESIUNIN, Moscow (RU); Vladimir Alexandrovich PESTRETSOV, Moscow (RU)

(21) Appl. No.: 19/331,381

(22) Filed: Sep. 17, 2025

(30) Foreign Application Priority Data
Sep. 20, 2024 (RU) 2024127801

(51) Int. Cl. H04B 1/04

(52) U.S. Cl. CPC H04B 1/0483; H04B 1/0458; H04B 2001/0408

(57) ABSTRACT

The disclosure relates to a fifth generation (5G) communication system or a sixth generation (6G) communication system for supporting higher data rates beyond a fourth generation (4G) communication system, such as long term evolution (LTE). According to an embodiment, a base station (BS) comprises, an antenna array including a plurality of antenna elements (AEs), the antenna array being divided into a plurality of subarrays, a plurality of transmission chains, each transmission chain being coupled to a corresponding subarray, and including a power amplifier, wherein at least two power amplifiers are configured to be turned off during operation of the base station, and a system comprising a plurality of commutators, each commutator being coupled to at least two of the plurality of transmission chains, wherein each commutator comprises, an input connected to an output of a corresponding power amplifier, an output connected to an input of the corresponding subarray, and a power divider subsystem including at least one power divider, wherein each of the at least one power divider comprises, an input coupled to an input of a commutator, and at least two outputs coupled to at least two outputs of the commutator.

### CROSS-REFERENCE TO RELATED APPLICATION(S)

This application is based on and claims priority under 35 U.S.C. § 119 (a) of a Russian patent application number 2024127801, filed on Sep. 20, 2024, in the Federal Service for Intellectual Property Administration, the disclosure of which is incorporated by reference herein in its entirety.

### BACKGROUND

### 1. Field

The disclosure relates to the field of communication. More particularly, the disclosure relates to a method and an apparatus for a reconfigurable subarray architecture (RSA) and obtaining channel state information (CSI) in a wireless communication system.

### 2. Description of Related Art

Considering the development of wireless communication from generation to generation, the technologies have been developed mainly for services targeting humans, such as voice calls, multimedia services, and data services. Following the commercialization of 5th generation (5G) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6th generation (6G) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bit per second (bps) and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz (THz) band (for example, 95 gigahertz (GHz) to 3THz bands). It is expected that, due to severer path loss and atmospheric absorption in the terahertz bands than those in millimeter wave (mmWave) bands introduced in 5G, technologies capable of securing the signal transmission distance (that is, coverage) will become more crucial. It is necessary to develop, as major technologies for securing the coverage, Radio Frequency (RF) elements, antennas, novel waveforms having a better coverage than Orthogonal Frequency Division Multiplexing (OFDM), beamforming and massive Multiple-input Multiple-Output (MIMO), Full Dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, Orbital Angular Momentum (OAM), and Reconfigurable Intelligent Surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, High-Altitude Platform Stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of Artificial Intelligence (AI) in wireless communication for improvement of overall network operation by utilizing AI from a designing phase for developing 6G and internalizing end-to-end AI support functions; and a next-generation distributed computing technology for overcoming the limit of user equipment (UE) computing ability through reachable super-high-performance communication and computing resources (such as Mobile Edge Computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended Reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and an apparatus for a reconfigurable subarray architecture (RSA) and obtaining channel state information (CSI) based on in a wireless communication system.

Another aspect of the disclosure is to provide a communication method in a wireless communication system.

Another aspect of the disclosure is to provide efficient communication methods in a wireless communication system.

Additional aspects will be set forth in part in the description which follows and, in part, will be apparent from the description, or may be learned by practice of the presented embodiments.

In accordance with an aspect of the disclosure, A base station (BS) comprises. an antenna array including a plurality of antenna elements (AEs), the antenna array being divided into a plurality of subarrays, a plurality of transmission chains, each transmission chain being coupled to a corresponding subarray, and including a power amplifier, wherein at least two power amplifiers are configured to be turned off during operation of the base station, and a system comprising a plurality of commutators, each commutator being coupled to at least two of the plurality of transmission chains, wherein each commutator comprises, an input connected to an output of a corresponding power amplifier, an output connected to an input of the corresponding subarray, and a power divider subsystem including at least one power divider, wherein each of the at least one power divider comprises, an input coupled to an input of a commutator, and at least two outputs coupled to at least two outputs of the commutator.

In accordance with an aspect of the disclosure, a transmitting apparatus of a base station (BS) is provided. The transmitting apparatus includes an antenna array including antenna elements (AEs), wherein the antenna array is divided into subarrays, wherein each subarray includes a transmission chain, wherein the transmission chain, at an output, is coupled to the subarray, wherein each transmission chain comprises a power amplifier, and wherein at least two power amplifiers in the transmitting apparatus are configured to be turned off in operation of the base station, a system of commutators where each commutator is included in at least two transmission chains, wherein the inclusion in each of the at least two transmission chains is implemented by a respective input of the commutator placed after an output of a power amplifier, and a respective output of the commutator, wherein the commutator comprises a power divider subsystem comprising at least one power divider, and wherein each power divider of the at least one power divider comprises an input coupled to one input of the commutator, and at least two outputs each coupled to one output of the commutator, in such a way that the commutator is configured to, when signals from power amplifiers of one or more of the at least two transmission chains are provided to respective one or more inputs of the commutator and power amplifiers of the other of the at least two transmission chains are off, by means of the power divider subsystem, forward incoming signals from the respective one or more inputs of the commutator to the outputs of the commutator.

In accordance with another aspect of the disclosure, a base station (BS) is provided. The BS includes a transmitting apparatus, including an antenna array including antenna elements (AEs), wherein the antenna array is divided into subarrays, each subarray including a transmission chain, wherein each transmission chain, at an output, is coupled to the subarray, and wherein each transmission chain includes a power amplifier, and a system of commutators where each commutator is included in at least two transmission chains, each commutator including a power divider subsystem including at least one power divider, wherein at least two power amplifiers in the transmitting apparatus are configured to be turned off in operation of the base station, wherein the inclusion in each of the at least two transmission chains is implemented by a respective input of the commutator placed after an output of a power amplifier, and a respective output of the commutator, wherein each power divider of the at least one power divider comprises an input coupled to one input of the commutator, and at least two outputs each coupled to one output of the commutator, in such a way that the commutator is configured to, when signals from power amplifiers of one or more of the at least two transmission chains are provided to respective one or more inputs of the commutator and power amplifiers of the other of the at least two transmission chains are off, by means of the power divider subsystem, forward incoming signals from the respective one or more inputs of the commutator to the outputs of the commutator.

In accordance with another aspect of the disclosure, a method performed by a base station (BS) comprising a transmitting apparatus in a wireless communication system is provided. The method includes transmitting, to a user equipment (UE), channel state information (CSI) reference signals (CSI-RSs), wherein the CSI-RSs relate to two or more CSI-RS resource sets, where at least two CSI-RS resource sets of the two or more CSI-RS resource sets have a different a number of CSI-RS ports of a CSI-RS resource, transmitting, to the UE, a CSI request, the CSI request comprising at least an indication of two or more CSI-RS resources from different CSI-RS resource sets among the two or more CSI-RS resource sets, and receiving, from the UE, CSI with respect to at least two of the two or more CSI-RS resources indicated by the indication in the CSI request, the CSI comprising respective parameters for each of the at least two CSI-RS resources.

In accordance with another aspect of the disclosure, a method performed by a user equipment (UE) in a wireless communication system is provided. The method includes receiving, from a base station (BS), channel state information (CSI) reference signals (CSI-RSs), wherein the CSI-RSs relate to two or more CSI-RS resource sets, where at least in two CSI-RS resource sets of the two or more CSI-RS resource sets a number of CSI-RS ports of a CSI-RS resource are different, receiving, from the BS, a CSI request, the CSI request comprising at least an indication of two or more CSI-RS resources from different CSI-RS resource sets among the two or more CSI-RS resource sets, obtaining CSI with respect to at least two of the two or more CSI-RS resources indicated by the indication in the received CSI request, wherein the CSI comprises respective parameters for each of the at least two CSI-RS resources, and transmitting, to the BS, the CSI.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A and 1B illustrate implementations of antenna muting (AM) supported in 5G new radio (NR) according to various embodiments of the disclosure;

FIGS. 2A and 2B illustrate negative effects associated with AM according to 5G NR according to various embodiments of the disclosure;

FIG. 3 illustrates interaction between a base station and a user equipment according to 5G NR to provide downlink (DL) beamforming according to an embodiment of the disclosure;

FIG. 4 illustrates transmission of channel state information reference signals (CSI-RSs) in different analog beams according to an embodiment of the disclosure;

FIGS. 5A and 5B illustrate interaction between a base station and a user equipment respectively for the two implementations of the AM technology of 5G NR according to various embodiments of the disclosure;

FIG. 6 illustrates a wireless communication system according to an embodiment of the disclosure;

FIG. 7 illustrates a general scheme of a base station transmitting apparatus according to an embodiment of the disclosure;

FIG. 8 illustrates a general scheme of a commutator of the system of commutators of the transmitting apparatus according to an embodiment of the disclosure;

FIGS. 9A and 9B illustrate a commutator according to various embodiments of the disclosure;

FIG. 10 illustrates a multi-level system of commutators according to an embodiment of the disclosure;

FIG. 11 illustrates a commutator according to an embodiment of the disclosure;

FIG. 12 illustrates inclusion of phase shifters into the transmission chains of FIG. 7 according to an embodiment of the disclosure;

FIG. 13 illustrates inclusion of a phase shifter(s) for implementation of the commutator according to FIG. 9A according to an embodiment of the disclosure;

FIG. 14 illustrates advantages of the RSA in relation to the prior art according to an embodiment of the disclosure;

FIG. 15 illustrates interaction between a base station and a user equipment according to an embodiment of the disclosure;

FIGS. 16A, 16B, 16C, 17A, and 17B illustrate channel state information (CSI) parameters arrangement within uplink control information (UCI) according to various embodiments of the disclosure;

FIG. 18 illustrates a flowchart of a method of obtaining CSI according to an embodiment of the disclosure;

FIG. 19 is a block diagram of a terminal or user equipment (UE) according to an embodiment of the disclosure;

FIG. 20 is a block diagram of a base station (BS) according to an embodiment of the disclosure; and

FIG. 21 is a block diagram of a network entity according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the accompanying drawings, some elements may be exaggerated, omitted, or schematically illustrated. Further, the size of each element does not completely reflect the actual size. In the drawings, identical or corresponding elements are provided with identical reference numerals or different reference numerals.

The advantages and features of the disclosure and ways to achieve them will be apparent by referring to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Furthermore, in describing the disclosure, a detailed description of known functions or constitution incorporated herein will be omitted in the case that it is determined that the description may make the subject matter of the disclosure unnecessarily unclear. The terms which will be described below are terms defined in consideration of the functions in the disclosure, and may be different according to users, intentions of the operators, or customs. Therefore, the definitions of the terms should be made based on the contents throughout the specification.

Herein, it will be understood that each block of the flowchart illustrations, and combinations of blocks in the flowchart illustrations, may be performed based on computer program instructions. These computer program instructions may be loaded collectively onto at least one processor of a general purpose computer, special purpose computer, or other programmable data processing apparatus to produce a machine, such that the instructions, which perform through any one of, or in any combination of, the at least one processor of the computer or other programmable data processing apparatus, create means for performing the functions specified in the flowchart block(s). These computer program instructions may also be stored in a non-transitory computer usable or computer-readable memory that may direct a computer or other programmable data processing apparatus to function in a particular manner, such that the instructions stored in the computer usable or computer-readable memory produce an article of manufacture including instruction means that perform the function specified in the flowchart block(s). The computer program instructions may also be loaded onto a computer or other programmable data processing apparatus to cause a series of operational steps to be performed on the computer or other programmable data processing apparatus to produce a computer executed process such that the instructions that perform on the computer or other programmable data processing apparatus provide steps for executing the functions specified in the flowchart block(s).

Further, each block may represent a module, segment, or portion of code, which includes one or more executable instructions for executing the specified logical function(s). It should also be noted that in some alternative implementations, the functions noted in the blocks may occur out of the order. For example, two blocks (or functions) shown in succession may in fact be performed substantially concurrently or the blocks may sometimes be performed in the reverse order, depending upon the functionality involved.

As used in embodiments of the disclosure, a “˜unit” may refer to a software element or a hardware element, such as a field programmable gate array (FPGA) or an application specific integrated circuit (ASIC), which performs a predetermined function. However, the term including the word “˜unit” does not always have a meaning limited to software or hardware. The “˜unit” may be constructed either to be stored in an addressable storage medium or to execute one or more processors. Therefore, the “˜unit” includes, for example, software elements, object-oriented software elements, components such as class elements and task elements, processes, functions, properties, procedures, sub-routines, segments of a program code, drivers, firmware, micro-codes, circuits, data, database, data structures, tables, arrays, and parameters. The components and functions provided by the “˜unit” may be either combined into a smaller number of components and a “˜unit,” or divided into additional components and a “˜unit.” Moreover, the components and “˜units” may be implemented to reproduce one or more central processing units (CPUs) within a device or a security multimedia card. Further, in the embodiments, the “^{˜}unit” may include one or more processors.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments of the disclosure may provide a program comprising code for implementing apparatus or a method as claimed in any one of the claims of this specification and a non-transitory machine-readable storage storing such a program.

Hereinafter, the determination of priority between A and B in the disclosure may refer to various actions such as selecting the one having a higher priority based on a predefined priority rule and performing an operation corresponding thereto, or omitting or dropping an operation corresponding to the one having a lower priority.

Hereinafter, “A or B” as described in the disclosure may be understood as “A and/or B,” which may include A, or B, or both A and B.

In addition, “at least one of A, B, and C” as described in the disclosure may be understood to include A, or B, or C, or any combination of A, B, and C.

In addition, “at least one of A, B, or C” as described in the disclosure may be understood to include A, or B, or C, or any combination of A, B, and C.

Furthermore, “A/B” as described in the disclosure may be understood as “A and/or B,” which may include A, or B, or both A and B.

Furthermore, “A, B” as described in the disclosure may be understood as “A and/or B,” which may include A, or B, or both A and B.

Furthermore, “A and B” as described in the disclosure may be understood as “A and/or B,” which may include A, or B, or both A and B.

Furthermore, “if condition A and condition B are satisfied,” as described in the disclosure, may not be limited to a case where both condition A and condition B are satisfied, but may be understood to include a case where either condition A or condition B is individually satisfied, both condition A and condition B are satisfied, or one or more additional conditions are satisfied in combination.

Furthermore, throughout this disclosure, ordinal terms such as “first,” “second,” “third,” etc., (and similar qualifiers) are used merely to distinguish between different instances, occurrences, configurations, messages, stages, or aspects of elements, operations, or information as described herein. Unless the context clearly dictates otherwise, the use of such ordinal terms does not itself require that the elements, operations, or information distinguished by these terms be structurally different, numerically distinct, or substantively dissimilar. For example, a “first signal” and a “second signal” may refer to instances of the same signal transmitted at different times or containing the same core information despite minor variations, or they may refer to signals with different content or characteristics, depending on the specific context. Similarly, a “first value” and a “second value” may represent the same magnitude but measured or applied in different circumstances, or they may represent different magnitudes. The interpretation should be guided by the specific technical context, function, and relationship described in the relevant portion of the specification and claims.

Furthermore, the terms “first ˜”, “second ˜”, etc., as described in the disclosure with respect to various elements (e.g., information, objects, operation, sequences, or the like), should not limit those elements. These terms may only be intended to distinguish one element from another, and may not be intended to indicate a specific order. For example, a first element could be termed a second element, and, similarly, a second element could be termed a first element.

Furthermore, even if “first ˜” and “second ˜” are described in the disclosure, it may be understood that element(s) referred to by “first ˜” and “second ˜” may be the same or different. For example, in case of element(s) being information, first information and second information may both be same information and, in some cases, are separate and different information.

In addition, the terms “if ˜” and “in case that ˜” as used in the disclosure or claims may be interpreted to include the meanings of “when (or upon) ˜,” “in response to ˜,” “based on ˜,” or “according to ˜,” and may be used interchangeably with these expressions. In addition, expressions other than those exemplified herein may also be used, as long as they have substantially the same meaning and do not impair the technical features of the disclosure.

For example, the physical layer signaling may be referred to as Layer 1 (L1) signaling and may include downlink control information (DCI). In addition, the higher layer signaling may include a medium access control (MAC) control message, a radio resource control (RRC) signaling message, a non-access stratum (NAS) signaling message, or an application layer message. The RRC signaling message may be referred to as layer 3 (L3) signaling. It should be noted, however, that the higher layer signaling is not limited to the aforementioned examples.

In addition, the term “not perform” as used in the disclosure or claims may, in context, be understood to mean that the corresponding step is omitted or skipped. Such a term may be replaced with other terms having the same or substantially equivalent meaning.

In addition, “transmitting a message including A and B” as described in the disclosure, may be understood as encompassing both (i) transmitting A and B in a single message, and (ii) transmitting A and B separately via multiple messages (e.g., transmitting a first message including A and a second message including B). This interpretation may also apply to messages that include two or more items (e.g., A, B, C), transmitted either together or separately.

In addition, “transmitting a message including A and transmitting a message including B” may also be interpreted as transmitting a message including A and B in a single message.

In the specific embodiments of the disclosure described below, terms or components included in the disclosure may be expressed in singular or plural form depending on the specific embodiments presented. However, such singular or plural expressions are selected appropriately for convenience of description, and the disclosure is not limited to a singular or plural number of components. A component expressed in the plural form may be implemented as a single component, and a component expressed in the singular form may be implemented as multiple components.

The drawings or flowcharts described below illustrate methods that may be implemented according to the principles of the disclosure, and various modifications may be made to the methods illustrated in the flowcharts of the disclosure. For example, although illustrated as a series of steps, various steps in each drawing or flowchart may overlap, occur in parallel, occur in a different order, or be repeated. In other examples, any step may be omitted or replaced with another step.

The methods and apparatuses proposed in the embodiments of the disclosure are not limited to each embodiment individually, but may also be applied in combination of all or some of the embodiments proposed in the disclosure. Therefore, the embodiments of the disclosure may be modified and applied without significantly departing from the scope of the disclosure, as would be understood by those skilled in the art.

In this case, even if certain wordings are described differently across embodiments, they may be used interchangeably or in substitution or in combination if their underlying concepts are equivalent. For example, for the same or equivalent concept, even if one embodiment uses the expression “A” and another embodiment uses the expression “B”, such expressions may be understood interchangeably, in substitution, or in combination.

The terms used in the following description to refer to access nodes, network entities, messages, interfaces between network entities, various types of identification information, and the like, are provided merely for the convenience of explanation by way of example. Therefore, the disclosure is not limited to the terms described below, and other terms having equivalent technical meanings may also be used. Such terms may also be interchangeable with terms defined in any 3rd generation partnership project (3GPP) technical specifications (TS) where appropriate.

Hereinafter, a base station is an entity that allocates resources to terminals, and may be at least one of a next generation node b (gNode B), an evolved node b (eNode B), a Node B, a base station (BS), a wireless access unit, a BS controller, or a node on a network.

Furthermore, the base station of the disclosure may include a split architecture comprising a central unit (CU) and a distributed unit (DU). In this structure, the CU is configured to process the higher layers of the control and user planes, while the DU is configured to process lower-layer radio resource functions. The embodiments of the disclosure may be equally applicable to 5G base station architectures in which such CU and DU functional splits are implemented.

A terminal may include a UE, a mobile station (MS), a cellular phone, a smartphone, a computer, or a multimedia system capable of performing communication functions.

In the disclosure, a downlink (DL) refers to a radio link through which a BS transmits a signal to a UE, and an uplink (UL) refers to a radio link through which a UE transmits a signal to a BS.

Furthermore, hereinafter, 5th generation (5G) mobile communication technologies (e.g., 5G new radio (NR)), 6th generation (6G) mobile communication technologies may be described by way of example, but the embodiments of the disclosure may also be applied to other communication systems having similar technical backgrounds or channel types. For example, newly evolved mobile communication systems developed after 5G and 6G may be included. Furthermore, based on determinations by those skilled in the art, the embodiments of the disclosure may also be applied to other communication systems (e.g., Wi-Fi systems) through some modifications without significantly departing from the scope of the disclosure.

In the following description, the terms physical channel and signal may be used interchangeably with data or control signal. For example, the term physical downlink shared channel (PDSCH) refers to a physical channel through which data is transmitted, but the term PDSCH may also be used to refer to the data itself. That is, in the disclosure, the expression “transmit a physical channel” may be interpreted as being equivalent to the expression “transmit data or a signal via a physical channel.”

Hereinafter, in the context of the disclosure, higher layer signaling may refer to signaling corresponding to at least one or any combination of the following: master information block (MIB), system information block (SIB) or SIB M (M=1, 2, . . . ), radio resource control (RRC), or medium access control (MAC) control element (CE), or a non-access stratum (NAS) signaling message, or an application layer message. The RRC signaling message may be referred to as L3 signaling.

In addition, L1 signaling may refer to signaling corresponding to at least one or any combination of signaling techniques using the at least one or any combination of the following physical layer channels or signaling: physical downlink control channel (PDCCH), downlink control information (DCI), user equipment (UE)-specific DCI, group-common DCI, common DCI, scheduling DCI (e.g., DCI used for scheduling downlink or uplink data), non-scheduling DCI (e.g., DCI not used for scheduling downlink or uplink data) physical uplink control channel (PUCCH), or uplink control information (UCI). The L1 signaling message may be referred to as a physical layer signaling.

Hereinafter, the expression that information is configured by the BS, as used in the disclosure or claims, may, in context, be understood to mean that the terminal receives the corresponding information from the BS via a physical layer signaling or a higher layer signaling. Such an expression may be replaced with other terms having the same or substantially equivalent meaning.

Hereinafter, the operational principle of the disclosure will be described in detail with reference to the accompanying drawings.

Hereinafter reference is made to various embodiments of the disclosure which are illustrated in the accompanying drawings where the same reference numerals denote similar elements. It should be appreciated that the embodiments of the disclosure can have various forms and should not be considered to be limited by the descriptions given herein. Therefore, the various embodiments are described hereinbelow with reference to the drawings to explain the essence of the aspects of the disclosure.

Nowadays more and more active deployment of 5th Generation (5G) New Radio (NR) networks takes place, whose advantages and capabilities are broadly known.

Base stations (BSs) in a 5G NR system use massive antenna arrays (Massive MIMO (mMIMO)) comprising multiple transceiver antenna elements (AEs). Such antenna arrays enable to efficiently implement the multiple-input multiple-output (MIMO) technology, where a number of spatial streams referred to as MIMO layers can be transmitted to communicate data (e.g. physical downlink shared channel (PDSCH)) to a user equipment(s) (UE(s)).

An antenna array of a base station is divided into groups of antenna elements or subarrays, where the number of antenna elements in a subarray (or, in other words, the size of the subarray) is set in manufacturing the base station and, accordingly, is constant during operation of the base station.

In a transceiver of the base station, each subarray of the antenna array has its own transmission chain connected thereto. The transmission chain comprises, in particular, a digital-to-analog converter (DAC) whose input is provided with a respective signal from the digital part of the base station, a power amplifier (PA), and a band-pass filter whose output the subarray is connected to. Therefore, the subarray is a single physical emitting element of the antenna array of the base station.

Since the antenna array of the base station operates for reception as well and, accordingly, the subarray is a single receiving element of the antenna array, the abovementioned chain of transmission elements can be implemented as part of a transceiver chain. Hereinafter in the text of the specification and in the drawings, the terms ‘transmission chain’ and ‘transceiver chain’ can be used interchangeably without limitations.

Nowadays reduction of operating expenses associated with wireless communication systems is an important goal, inter alia—in the context of developing next generation communication systems. A significant contribution to the operating expenses of an operator of a wireless communication network is made by energy consumption of the network; accordingly, in the context of addressing this important goal, the general motivation is to use various power saving technologies in order to ensure high energy efficiency of the network.

As practice shows, energy consumption of power amplifiers of transceiver devices of base stations is a significant portion of total energy consumed by the radio access network in operation. Accordingly, this fact motivates a general approach to reducing power consumption of a base station(s), the approach being in temporarily transitioning some power amplifiers in transmission chains of the base station to the off state in cases where activity of all power amplifiers is not required.

In 5G NR, implementation of this general approach is the antenna muting (AM) technology according to which, depending on a number of characteristics, such as a current network traffic load, a current wireless channel, a location of a base station, the base station dynamically or semi-statically disables some transmission chains along with transitioning respective power amplifiers of the chains to the off state. As a result, transmission from subarrays whereto the disabled transmission chains are connected is not performed—in other words, these subarrays become muted.

In 5G NR, virtualization of subarrays of an antenna array of a base station (i.e. substantially of physical antennas) into logical ports is implemented. Depending on implementation, each subarray can be virtualized into one logical port, or more than one (for example, two) subarrays can correspond to one logical port. Each such logical port has its own channel state information (CSI) reference signal (RS) associated therewith; accordingly, this logical port is referred to as a CSI-RS port of the base station. Generally speaking, in 5G NR, CSI-RSs are transmitted from the base station to a user equipment(s), and the user equipment performs DL channel state measurement based on CSI-RSs received from the base station and transmits a report on the completed channel estimation to the base station in the form of CSI, so that the base station, based on the report, could perform an appropriate adjustment for subsequent DL data transmission to the user equipment. It should be noted that communication of the user equipment with the base station is carried out specifically in the level of CSI-RS ports of the base station, i.e. the user equipment may not be aware of a specific number of subarrays of the antenna array represented by a CSI-RS port.

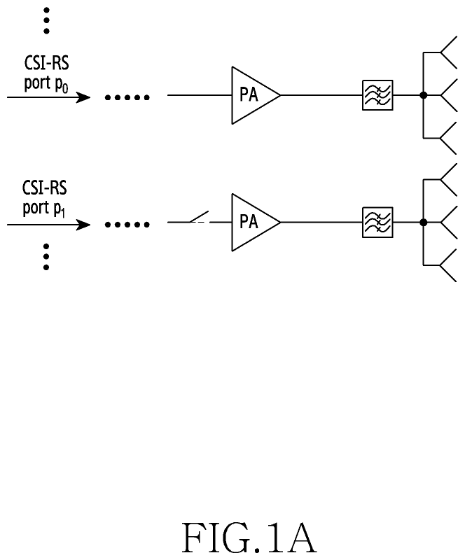

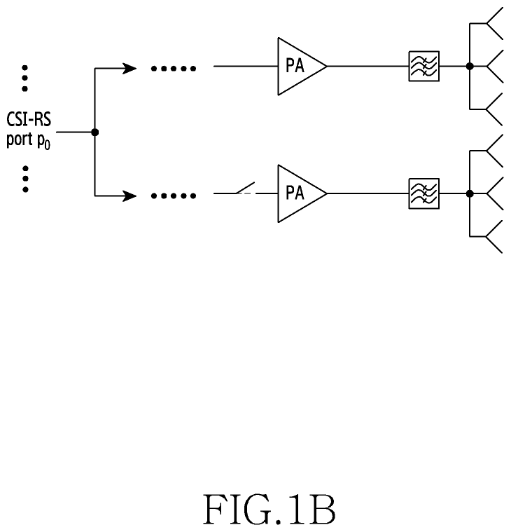

The description of implementations of the AM technology supported in 5G NR is provided below with reference to FIGS. 1A and 1B.

FIG. 1A shows a simplified schematic diagram of a transmitting apparatus of a base station for the case when one subarray is respectively virtualized into one CSI-RS port; as a result, a separate CSI-RS is associated with a specific subarray (Option 1) according to an embodiment of the disclosure. It should be appreciated by a skilled artisan in view of the aforesaid that the general term ‘base station transmitting apparatus’ may refer in this application, without limitations, to a transmission section or part of the base station transceiver device.

Referring to FIG. 1A, each subarray has a transmission chain coupled thereto, the transmission chain, as shown in this figure, including a power amplifier and a band-pass filter; a DAC (not shown in FIG. 1A) located at the input of the transmission chain is provided with a respective digital signal from the digital part of the base station. The digital signal provided to the input of the transmission chain can be a data signal (for example, physical downlink shared channel (PDSCH) or physical downlink control channel (PDCCH)) or a respective CSI-RS.

FIG. 1A shows, as an illustration, two neighboring transmission chains, where in one of the two chains (which is associated with CSI-RS port p1) a switch is symbolically shown, the switch enabling to dynamically turn off/on this transmission chain. When the transmission chain is turned off using the switch, the respective subarray becomes muted and CSI-RS port p1 will no longer be visible to user equipment. Generally speaking, when some power amplifiers are turned off, part of subarrays of the antenna array will stop transmitting respective CSI-RSs. Although the considered implementation provides reduction in power consumption, the muting of some CSI-RS ports may negatively affect quality of DL channel estimation at the side of user equipment.

FIG. 1B shows a simplified schematic diagram of a transmitting apparatus of a base station for the case of virtualization when one CSI-RS port (namely, CSI-RS port p0 according to the illustration) respectively represents two adjacent subarrays of the antenna array of the base station; as a result, a separate CSI-RS is associated with a specific pair of subarrays (Option 2) according to an embodiment of the disclosure.

Referring to FIG. 1B, as in the case of FIG. 1A, each subarray has a transmission chain coupled thereto, the transmission chain, as shown in FIG. 1B, including a power amplifier and a band-pass filter, where one respective CSI-RS is provided to the input of the both neighboring transmission chains from the digital part of the base station.

As in the case of FIG. 1A, FIG. 1B symbolically shows a switch in one of the two transmission chains (the lower one according to the illustration), the switch enabling to dynamically turn off/on this transmission chain. When the transmission chain is turned off using the switch, the respective subarray becomes muted, however, due to the virtualization option used in the AM implementation according to FIG. 1B, CSI-RS port p0 will not cease to be visible to user equipment. Generally speaking, when some power amplifiers are turned off, part of subarrays of the antenna array will be in the muted state, while CSI-RSs will continue to be transmitted from all CSI-RS ports of the base station. Therefore, when activating the AM mode according to the implementation illustrated in FIG. 1B, the procedure of transitioning the base station to the reduced power consumption mode, or, in other words, energy efficient (EE) mode, can be carried out transparently for the user equipment. It should be understood that, in the implementation according to Option 2, more than two subarrays can be virtualized into one CSI-RS port.

However, the following significant drawback is typical for both Option 1 and Option 2 of implementation of the AM technology supported in 5G NR. In addition to reduction of overall transmission power of the base station, which is inevitable in the context of the goal of reducing power consumption, due to the decrease of the ratio of active antenna elements, the antenna gain which the base station antenna array can provide in the direction of a specific user equipment via the respective beamforming (BF) is reduced.

It should be explained that, in 5G NR wireless communication systems, two approaches to DL beamforming are used for dynamically focusing a transmitted signal in one or more preset directions: analog beamforming (A-BF) and digital beamforming (D-BF). D-BF is performed in the digital part of the base station when generating a DL signal and can be used both in the time domain and in the frequency domain; A-BF is performed in the analog part of the base station (see FIGS. 1A and 1B) and is applied to the already generated signal, and only in the time domain. 5G NR supports adaptive methods of beamforming using A-BF and D-BF (i.e. hybrid beamforming (H-BF)).

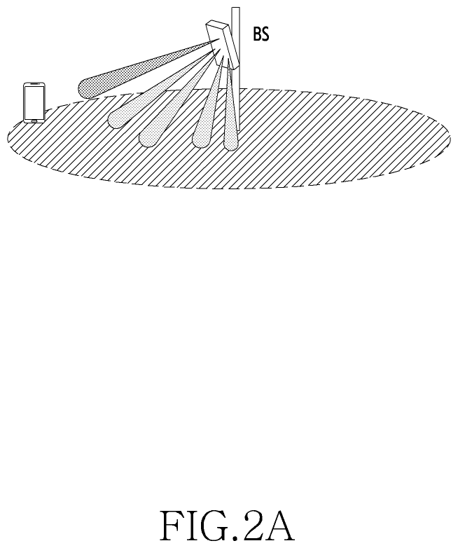

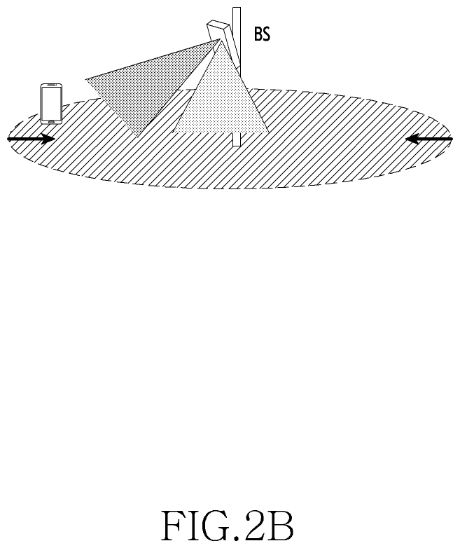

The negative effects associated with AM are illustrated in FIGS. 2A and 2B.

FIG. 2A shows the primary (i.e. not power saving) operation mode of the base station in which all power amplifiers are in the on state and, respectively, all antenna elements are active according to an embodiment of the disclosure. In the primary mode, high transmission power is ensured (obviously, at the expense of power saving), as well as a high antenna gain; accordingly, the base station is enabled to form narrow beams, for example, in the direction of user equipment located closer to the edge of the cell served by the base station. The capability of forming narrow beams, in turn, allows to significantly reduce interference with respect to user equipment in a neighboring cell(s).

FIG. 2B shows, substantially in comparison with FIG. 2A, the EE operation mode of the base station in which some power amplifiers are in the off state and respective subarrays are inactive according to an embodiment of the disclosure. In the case of illustration of the AM implementations according to any of FIGS. 1A and 1B, half of the subarrays will be muted.

Referring to FIG. 2B, as mentioned earlier, in the EE mode, transmission power is reduced, which can lead to degradation of coverage in the cell, as well as decrease in the antenna gain. Due to the decrease in the antenna gain, the base station can only form wider beams, which, in turn, can lead to increase in interference with respect to user equipment in the neighboring cell(s).

Thus, usage of the AM technology described above can lead to noticeable degradation of the system performance even in existing wireless communication systems.

Thereafter, the general description of the mechanism for obtaining and transmitting CSI used in 5G NR is given in order to provide more full understanding of the technical context of the disclosure.

As briefly recited earlier, in 5G NR, CSI-RSs are transmitted from a base station to a user equipment(s), so that the user equipment performs, based on the received CSI-RSs, determination of the DL channel state with respect to all or required part of CSI-RS ports. Appropriate A-BF can be applied in the analog part of the base station to CSI-RSs transmitted by the base station at a certain time instance, the A-BF setting a specific direction of the DL transmission or, in other words, an analog beam. In this regard, two A-BF strategies are supported in 5G NR. Analog beams corresponding to the first strategy are highly spatially-directed, with focusing of transmission power in a preset direction (i.e. narrow beams with a high gain), and are optimized for the single-user MIMO (SU-MIMO) mode, along with providing maximum throughput for individual user equipment. Accordingly, in the present disclosure such analog beams may be referred to as ‘SU-MIMO beams’ for brevity. Analog beams corresponding to the second strategy are wider with a lower gain and, accordingly, are aimed at providing simultaneous data transmission to multiple user equipment (i.e., such beams are optimized for the multi-user MIMO (MU-MIMO) mode_. In the present disclosure, such beams may be referred to as ‘MU-MIMO beams’ for brevity. Of course, CSI-RSs can be transmitted by the base station without applying A-BF thereto.

For transmission of CSI-RSs, for example, performed at a certain time in a certain analog beam, respective orthogonal multiplexing of the CSI-RSs over frequency domain and time domain resources is applied in 5G NR. More specifically, the base station uses a specific CSI-RS configuration according to which time-frequency resources are divided into a predefined number of code division multiplexing groups (CDM groups) of a predefined size, the CDM groups being regularly arranged in frequency and time (e.g., the distance between adjacent CDM groups in frequency can be one subcarrier, and the distance between adjacent CDM groups in time can be one OFDM symbol); furthermore, in each of the predefined number of CDM groups, multiplexing of CSI-RSs is provided by applying respective orthogonal cover codes (OCC) in the frequency domain and in the time domain. Such CSI-RS configuration basically implements mapping of CSI-RS ports to time-frequency resources.

The 5G NR aspects related to mapping of base station CSI-RS ports to time-frequency resources of the CSI-RS configuration, with multiplexed transmission of CSI-RSs, are disclosed in specification TS 38.211, v.18.1.0 which is entirely included in the application by reference. In particular, this specification provides the table of CSI-RS configurations supported in 5G NR, along with their respective characteristics.

When connecting user equipment to the cell served by the base station, a number of configurations are transmitted to the user equipment from the base station, the configurations, in general, defining parameters for transmitting signals in the cell. In particular, one or more CSI-RS resources are configured for the user equipment via radio resource control (RRC) (L3) signaling. Each CSI-RS resource is encoded with a certain number of respective parameters. According to specification TS 38.331, which is entirely incorporated in the application by reference, the encoding is represented in the following form:

| | |
|---|---|
| NZP-CSI-RS-Resource ::= | SEQUENCE { |
| nzp-CSI-RS-ResourceId | NZP-CSI-RS-ResourceId, |
| resourceMapping | CSI-RS-ResourceMapping, |

powerControlOffset INTEGER (−8..15),

| | |
|---|---|
| powerControlOffsetSS | ENUMERATED{db-3, db0, db3, db6} |

OPTIONAL, -- Need R
scramblingID ScramblingId,

| | |
|---|---|
| periodicityAndOffset | CSI-ResourcePeriodicityAndOffset |

OPTIONAL,-

| | |
|---|---|
| qcl-InfoPeriodicCSI-RS | TCI-StateId OPTIONAL, -- Cond Periodic |

```
  ...
  },
  where
  CSI-RS-ResourceMapping ::= SEQUENCE {
  frequencyDomainAllocation CHOICE {
```

| | |
|---|---|
| row1 BIT STRING (SIZE (4)), row2 | BIT STRING (SIZE (12)), |
| row4 BIT STRING (SIZE (3)), other | BIT STRING (SIZE (6)) |

},

| | |
|---|---|
| nrofPorts | ENUMERATED |
| {p1,p2,p4,p8,p12,p16,p24,p32}, | |
| firstOFDMSymbolInTimeDomain | INTEGER (0..13), |
| cdm-Type | ENUMERATED {...}, |

```
  density CHOICE {
  dot5 ENUMERATED {evenPRBs, oddPRBs},
  one NULL, three NULL, spare NULL
  }, ... }
```

Parameter CSI-RS-ResourceMapping in the CSI-RS resource substantially sets specific mapping of CSI-RS ports to time-frequency resources for a specific CSI-RS configuration.

Furthermore, parameter powerControlOffset in the CSI-RS resource, which sets a power offset, is used for the following purpose. As noticed earlier, during multiplexed transmission of CSI-RSs, due to the usage of CDM groups, not all subcarriers can be used; accordingly, transmission power can be redistributed only to the subcarriers used for the CSI-RSs. At the same time, in subsequent data transmission being scheduled, all the subcarriers can be involved, and, hence, the data signal can be received by the user equipment with less power. Accordingly, parameter powerControlOffset serves to inform the user equipment, when configuring the CSI-RS resource for it, about the amount by which the power of CSI-RS transmission and the power of data transmission, which will be subsequently performed with adaptation based on respective CSI, will differ. In other words, the user equipment makes the adjustment by the predefined power offset value Pc during measurements of the CSI-RSs and, accordingly, during calculation of the CSI.

As noted earlier, more than one CSI-RS resource can be similarly configured for the user equipment, each of the CSI-RS resources corresponding to one of analog beams used by the base station. For instance, when such configuring is carried out for the user equipment, a set of CSI-RS resources can be encoded as follows:

NZP-CSI-RS-ResourceSet ::= SEQUENCE {

| | |
|---|---|
| nzp-CSI-ResourceSetId | NZP-CSI-RS-ResourceSetId, |
| nzp-CSI-RS-Resources | SEQUENCE (SIZE (1..maxNrofNZP- |
| CSI-RS-ResourcesPerSet)) | OF NZP-CSI-RS-ResourceId, |
| Repetition | ENUMERATED {on, off} OPTIONAL, |
| AperiodicTriggeringOffset | INTEGER(0..4) OPTIONAL, |
| trs-Info | ENUMERATED {true} OPTIONAL, |

...
},

where the CSI-RS resources included in the set are indicated by means of respective identifiers NZP-CSI-RS-ResourceId. For example, a set of CSI-RS resources can be configured for the user equipment for a corresponding set of SU-MIMO beams. In this case, the number of CSI-RS ports of a CSI-RS resource in the CSI-RS resource set is the same.

According to 5G NR, CSI-RSs can be transmitted by a base station in the following modes:
aperiodically, when the base station transmits CSI-RSs as needed, and a user equipment(s) is informed in advance (for example, via downlink control information (DCI)) about the CSI-RS transmission in a specific slot;
periodically, and in this case periodicity of the transmission is configured in the base station and signaled in advance to the user equipment(s);
semi-persistently, when configuring is performed similarly to the periodic mode, but the base station uses DL control signaling (for example, a medium access control (MAC) message) to activate/deactivate specific CSI-RS resources.

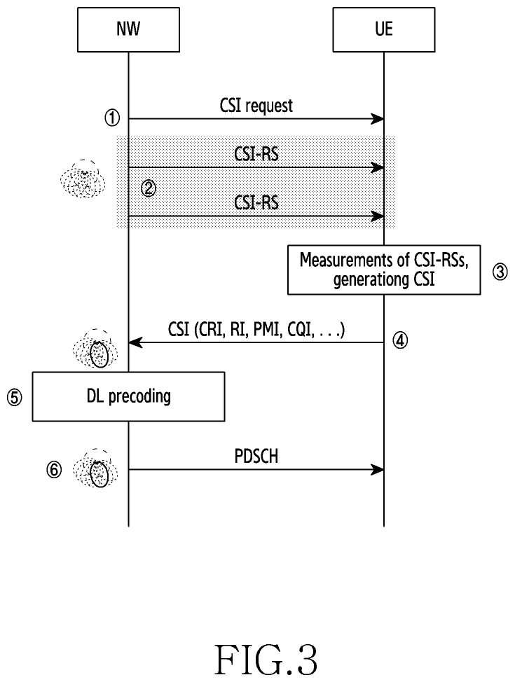

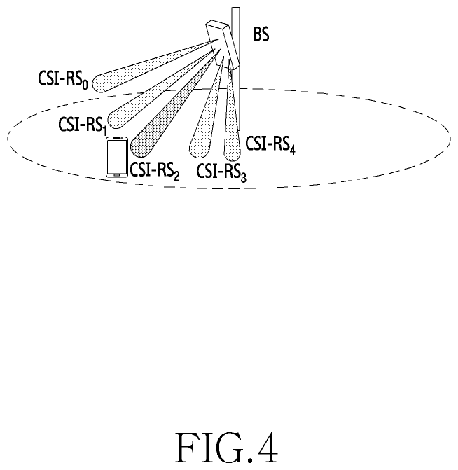

The aperiodic mode will be discussed below, without limitations, for illustrative purposes, with reference to the generalized scheme of an embodiment of interaction between a wireless communication network (NW) and a user equipment (UE) shown in FIG. 3, as well as with reference to the illustration according to FIG. 4.

FIG. 3 illustrates interaction between a base station and a user equipment according to 5G NR to provide DL beamforming according to an embodiment of the disclosure.

FIG. 4 illustrates transmission of CSI-RSs in different analog beams according to an embodiment of the disclosure.

Referring to FIGS. 3 and 4, a base station, which is part of the NW, transmits a CSI request to the user equipment (action 1 in FIG. 3), the CSI request, in particular, indicating a CSI-RS resource set, and performs respective transmission of CSI-RSs (action 2 in FIG. 3).

As illustrated in FIG. 4, the transmission of the indicated set of CSI-RS resources {CSI-RS₀, CSI-RS₁, CSI-RS₂, CSI-RS₃, CSI-RS₄} is carried out in respective five SU-MIMO beams.

The user equipment performs measurements of the received CSI-RSs and, based on the measurements, selects one CSI-RS resource. A report in the form of CSI will be generated in the user equipment specifically in relation to the selected CSI-RS resource (action 3 in FIG. 3); accordingly, an identifier (CRI) of the selected CSI-RS resource is included into the CSI. In particular, according to the illustration of FIG. 4, the selected CSI-RS resource is CSI-RS₂.

The CSI report also includes a number of parameters that are calculated in the user equipment based on the results of the measurements. In particular, the user equipment selects a preferred number of MIMO layers corresponding to a number of data streams simultaneously transmitted from the base station that the user equipment intends to receive. This number of MIMO layers is reflected by parameter RI as part of the CSI. In addition, the user equipment obtains a precoding matrix formed by discrete Fourier transform (DFT) vectors that define spatial directions recommended by the user equipment for transmitting the number of MIMO layers to the user equipment. The DFT vectors are selected from a predefined codebook, the parameters of the codebook can be signaled to the user equipment when configuring the CSI discussed above. The obtained precoding matrix is reflected by parameter PMI as part of the CSI. Moreover, the user equipment determines channel quality indicator (CQI) which is also included into the CSI and which should inform the base station about noise robustness of the DL channel between the base station and the user equipment and, accordingly, a modulation and coding scheme (MCS) that should be chosen.

The 5G NR aspects related, in particular, to implementation of the codebook, channel estimation based on CSI-RSs and obtaining a precoding matrix at the user equipment side, the specifics of representing and transmitting CRI, RI, PMI, CQI, and other parameters within CSI, are disclosed in specifications TS 38.212 (see, in particular, section 6.3.2.1.2), TS 38.214 (see, in particular, section 5.2.2.1), and are also reflected in publications RU 2811989, RU 2824924, all of which are fully included in this application by reference. In particular, 5G NR Type 1 codebook (see Table 5.2.2.2.1-2 from TS 38.214) can be used as the codebook. It should be noted that RU 2811989 also discloses advanced technologies for implementing DL precoding, and RU 2824924 also discloses advanced technologies of multiplexing CSI-RSs.

The obtained CSI, including inter alia RI, PMI, CQI for the selected CSI-RS resource (CSI-RS2), is transmitted from the user equipment to the base station via uplink control information (UCI) (action 4 in FIG. 3). It should be noticed that, according to 5G NR, PMI is represented in the CSI by two parameters: PMI1 and PMI2, where PMI1 relates to DFT vectors of the precoding matrix, and PMI2 corresponds to polarization co-phasing in the precoding matrix.

Upon reception of the CSI, the base station, in particular, uses CQI to select MCS and applies the obtained precoding matrix to carry out respective beamforming (action 5) for performing transmission (for example, of PDSCH) to the user equipment (action 6). The parameters included in the received CSI are substantially used by the base station to optimally adapt parameters of the subsequent DL data transmission to the reported DL channel state.

According to 5G NR, the CSI request can be directed with respect to only one CSI-RS resource or one CSI-RS resource set. That is, for example, if, in addition to the set of CSI-RS resources corresponding to SU-MIMO beams, the base station needs to obtain a CSI report with respect to another set of CSI-RS resources corresponding to MU-MIMO beams, then the base station will need to transmit a separate CSI request to the user equipment in relation to the other CSI-RS resource set; a respective separate CSI report will be transmitted from the user equipment, similarly to the above disclosure according to FIG. 3. It should be noted that, in this case, the number of CSI-RS ports of a CSI-RS resource in the CSI-RS resource set corresponding to SU-MIMO beams and the number of CSI-RS ports of a CSI-RS resource in the CSI-RS resource set corresponding to MU-MIMO beams is the same.

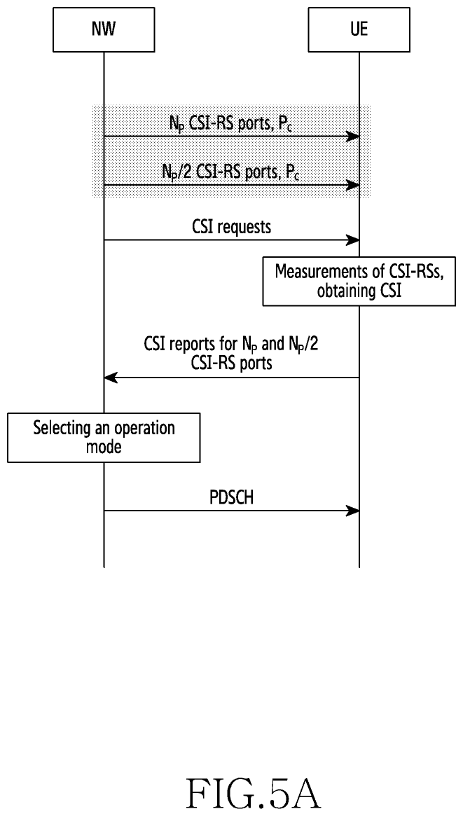

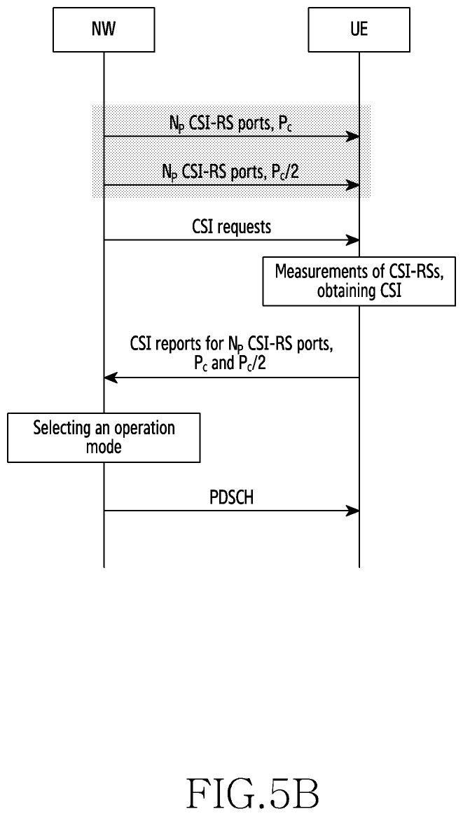

This aspect is illustrated below with reference to FIGS. 5A and 5B in relation to the two AM options described above with reference to FIGS. 1A, 1B, 2A, and 2B.

FIGS. 5A and 5B illustrate interaction between a base station and a user equipment respectively for the two implementations of the AM technology of 5G NR according to various embodiments of the disclosure.

Referring to FIGS. 5A and 5B, each figure characterizes situations where (i) CSI-RSs are transmitted in the primary operation mode of the base station, i.e. when all power amplifiers are in the on state and, accordingly, the transmission is carried out from all subarrays, in other words, from all Np CSI-RS ports, and (ii) CSI-RSs are transmitted in a respective EE mode of the base station, i.e. when, according to the disclosure of FIGS. 1A and 1B, half of the power amplifiers are in the off state and, accordingly, the transmission is carried out from half of subarrays. The EE mode of the base station is provided by a respective AM option.

Referring to FIG. 5A, in a format similar to FIG. 3, an illustration is given that corresponds to Option 1 of AM in FIG. 1A. According to this illustration, in the primary mode, the base station transmits CSI-RSs from all Np CSI-RS ports and, in the EE mode, the base station transmits CSI-RSs from Np/2 CSI-RS ports. As mentioned earlier, for each of these transmissions, a separate CSI request will be transmitted from the base station to the user equipment, the one of these CSI requests, which corresponds to the primary mode, will indicate a CSI-RS resource with the Np CSI-RS ports, and the other one, which corresponds to the EE mode, will indicate a CSI-RS resource with the Np/2 CSI-RS ports; in both CSI-RS resources, the power offset is set to the same value Pc.

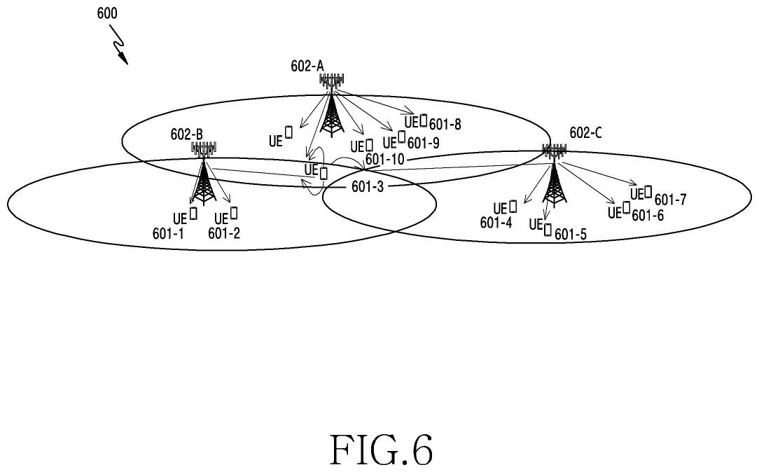

FIG. 6 illustrates a wireless communication system according to an embodiment of the disclosure.

Referring to FIG. 6, user equipment (UE) 601 communicate with base station (BS) 602 in a radio access network (RAN) 600. The UEs 601 (e.g., UE 601-1, 601-2, 601-3, . . . , 601-10) are distributed over the RAN 600, and each of the UEs 601 can be fixed or mobile. Broadly known examples of UEs are smartphones, tablets, modems, etc.

The base stations 602 (e.g., BSs 602-A, 602-B, 602-C) may provide coverage for a specific geographic area commonly referred to as ‘cell’. The base stations 602 basically have fixed structure, but they can have mobile implementation as well. In general, the base stations can represent macro-BSs (as illustrated by the BSs 602-A, 602-B, 602-C in FIG. 6), as well as pico base stations for pico-cells or femto base stations for femto-cells. Cells in turn can be divided into sectors.

Coordination and management of operating the base stations 602 can be provided by a network controller which is in communication therewith (for instance, via a backhaul connection). The RAN 600 may communicate with a core network (CN) (for example, via the network controller) which provides various network functions, such as e.g. access and mobility management, session management, authentication server function, application function, etc. Moreover, the base stations 602 in the RAN 600 can also connect to each other, for instance, via a direct physical connection, which is preferably a high-speed connection.

When a user equipment is moving within the RAN 600, handover of the user equipment from one base station to another base station can be performed. For example, the UE 601-3 can be handed over from the BS 602-B to the BS 602-A. While performing this, respective communication system parameters are reconfigured in the user equipment for operation with the new base station. The user equipment can be also handed over between sectors of one base station.

The Open RAN (O-RAN) architecture is implemented in 5G NR—in particular, O-RAN 7-2x-which comprises dividing the base station into two parts and using a fronthaul (FH) interface defined for exchanging information between these functional parts. More specifically, according to this architecture, the base station is divided into a radio unit (RU) and a distributed unit (DU) that are connected to each other via the FH interface. Support for the O-RAN architecture is expected in 6G xMIMO wireless communication systems. Moreover, the aspects associated with the RSA according to the disclosure can be implemented in the RU.

Each of the BSs 602 shown in FIG. 6 includes hardware and logical means to implement respective functions in the base station. The hardware means refer to, in particular, an antenna array comprised of transceiver antenna elements which have been discussed above, various specially configured processors, controllers, data storage devices, other circuit elements, as well as buses connecting them. The logical means refer to software which is stored in respective memory devices and configures respective circuit elements. Firmware directly hardwired in processors and controllers also refers to the software. The abovementioned hardware means are configured inter alia to perform various processing with respect to transmitted and received signals, including (de) modulation, (de) multiplexing, (de) coding, amplifying, filtering, digitizing, (de) interleaving, resource allocation, reception/transmission scheduling.

In a similar way, each of the UEs 601 shown in FIG. 6 includes hardware and logical means to implement respective functions in the user equipment. The hardware means refer to, in particular, transceiver devices with respective antenna elements, various specially configured processor(s), controllers, data storage devices, other circuit elements, as well as buses connecting them. The logical means refer to software which is stored in respective memory devices and configures respective circuit elements. Firmware directly hardwired in controllers also refers to the software. The indicated hardware means are configured inter alia to perform various processing with respect to transmitted and received signals, including (de) modulation, (de) multiplexing, (de) coding, amplifying, filtering, digitizing, (de) interleaving. Moreover, the user equipment comprises means to interact with a user, including a touch screen, speakers/microphone, buttons, as well as user applications which are stored in the memory of the user equipment and executed by the processor of the user equipment in a respective operating system.

Examples of the abovementioned processors/controllers include microprocessors, microcontrollers, digital signal processors (DSPs), field programmable gate arrays (FPGAs), discrete hardware integrated circuits, etc. Firmware/software executed by the processors/controllers should be understood broadly, as referring to computer-executable instructions, instruction sets, program code, code segments, subroutines, program modules, objects, procedures, etc. The software is stored in respective computer-readable media which can be implemented e.g. in the form of random-access memory (RAM), read-only memory (ROM), electrically erasable programmable (EEPROM), solid state storage devices, magnetic storage devices, optical storage devices, etc. which can be recorded with respective program codes and data structures that can be accessed by respective processors/controllers.

The hardware and software elements of the base station and the user equipment, as listed above, are configured to provide execution, in the base station and in the user equipment, of the methods according to the application which are described below. Implementation of the component hardware of the base station and user equipment and specialized configuring thereof, including by respective logical means, are known in the technical field which the application relates to. Furthermore, various functions according to the application can be executed in multiple separate elements or in one or more integral elements, which is defined by design structural characteristics.

In order to solve the important technical problem outlined above when discussing the related art, according to the first aspect of the disclosure the reconfigurable subarray architecture (RSA) is provided which is implemented in a transmitting apparatus of a base station. As noted earlier, the base station transmitting apparatus in this application can be refer, without limitation, to the transmitting section of the base station transceiver device (for example, the radio unit in the case of the O-RAN architecture). As in the case of 5G NR, a component of the transmitting apparatus is the base station antenna array comprised of antenna elements that are structured in subarrays having the same number of antenna elements, during manufacturing; each subarray has its own transmission chain coupled thereto, i.e., in other words, the transmission chain is connected at its output to the subarray.

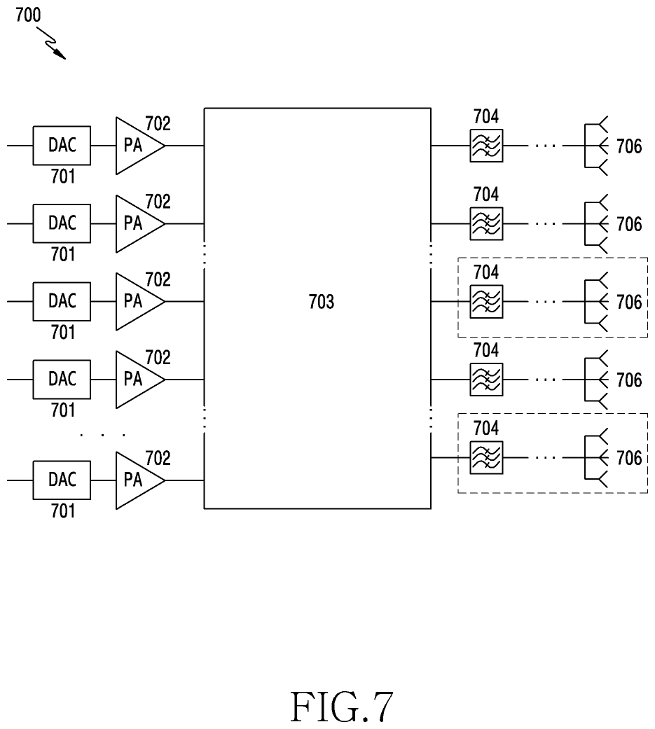

FIG. 7 shows a general scheme of a transmitting apparatus 700 of a base station according to the first aspect of the disclosure.

Referring to FIG. 7, as in 5G NR, at the input of each transmission chain there is a DAC 701 to which a respective signal is provided from the digital part of the base station (e.g., from the remote unit in the case of the O-RAN architecture); a power amplifier 702 is connected to the output of the DAC-therefore, a respective analog signal is applied from the output of the DAC 701 to the input of the power amplifier 702. Moreover, at least one of the power amplifiers 702 are configured to be turned off during operation of the base station to ensure transition to an EE mode. As an option, all of the power amplifiers can be configured to be disabled, or at least one of the power amplifiers can be configured to not be disabled.

According to the first aspect of the disclosure, a system 703 of commutators is included in the transmission chains of the transmitting apparatus of the base station, the system providing flexible and dynamic forwarding of signals provided to the system of commutators, and redistribution of their power towards outputs of transmission chains connected to respective subarrays 706 of the antenna array. In each subarray 706 in FIG. 7, three antenna elements are illustratively shown, which does not impose a limitation onto the disclosure. The detailed disclosure of the aspects of the structure of the system 703 of commutators and inclusion thereof into transmission chains will be given below.

As in the case of 5G NR, a band-pass filter 704 is provided in each transmission chain, the band-pass filter being located before the output of the transmission chain. According to the illustration of FIG. 7, in the base station transmitting apparatus according to the disclosure, band-pass filters 704 in transmission chains are connected to outputs of the system 703 of commutators. In accordance with a possible embodiment, the output of a band-pass filter 704 can be directly connected to a respective subarray 706, similarly to the discussion according to FIG. 1A.

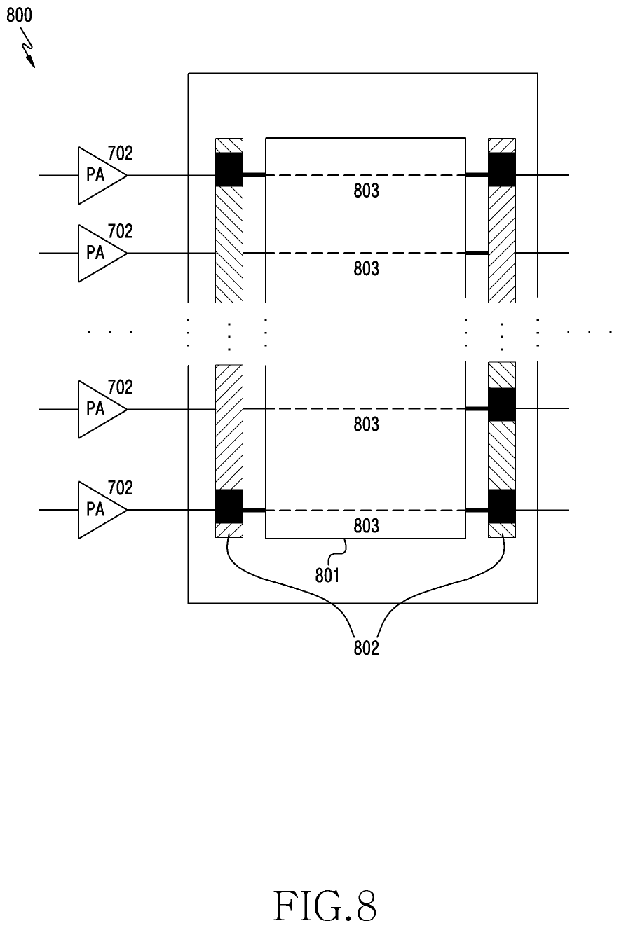

Referring to FIG. 8, in the context of the disclosure of the system 703 of commutators of the base station transmitting apparatus, illustrates the general description of one commutator 800 of the system 703 of commutators according to an embodiment of the first aspect of the disclosure is given.

Referring to FIG. 8, each commutator 800 of the system 703 of commutators is included in a number of transmission chains of the transmitting apparatus. The inclusion of the commutator 800 in each of the number of transmission chains is implemented by means of a respective one input of the commutator and a respective one output of the commutator. As follows from FIGS. 7 and 8, the inputs of the commutator 800 are connected to the outputs of the power amplifiers 702 of the respective transmission chains.

The commutator 800 comprises a power divider subsystem 801 which comprises one or more power dividers, as well as a switch subsystem 802 comprising output switches at the outputs of the commutator and input switches at the inputs of the commutator. In addition, in the commutator 800, for each transmission chain from the number transmission chains in which the commutator is included, there is a pass-through line 803 (symbolically shown as a dashed line) designed to directly connect the commutator input with the commutator output in this transmission chain.

As illustratively shown in FIG. 8, outputs of power dividers of the power divider subsystem 801 are connected, via the switch subsystem 802, to the outputs of the commutator 800, and inputs of the power dividers are connected, via the switch subsystem 802, to part of the inputs of the commutator 800 (this connection is illustrated in FIG. 8 by bold lines connecting the inputs of the power divider subsystem 801 to the inputs of the commutator 800). In accordance with the considered embodiment, the switch subsystem 802 comprises an output switch at each output of the commutator 800 (symbolically shown as a black square), and the outputs of the power dividers of the power divider subsystem 801 are one-to-one connected, via respective output switches, to all the outputs of the commutator 800. Then, the switch subsystem 802 comprises an input switch at each input of the commutator 800 to which an input of a power divider of the power divider subsystem 801 is connected (the input switches are also symbolically shown as black squares in FIG. 8); accordingly, the inputs of the power dividers are one-to-one connected, via respective input switches, to the part of the inputs of the commutator 800.

The switch subsystem 802 can have the pass-through state of switches in which all the pass-through lines 803 are in the connected state and the power divider subsystem 801 is in the disconnected state. The pass-through state can be used in the primary operation mode of the base station, when all power amplifiers in transmission chains are active and, therefore, respective signals are to be directly applied to subarrays.

The switch subsystem 802 can also have at least one distributing state of switches in which the pass-through lines 803 are in the disconnected state and the power divider subsystem 801 is in a respective at least one connected state. A distributing state can be used in a respective EE operation mode of the base station when some of power amplifiers in transmission chains are in the off (inactive) state for energy saving purposes. Implementations of distributing states of switches of the switch subsystem 802 of the commutator 800 will be disclosed below.

According to the first aspect of the disclosure, when signals are provided from respective active power amplifiers 702 to one or more (e.g., to all) of the part of the inputs of the commutator and power amplifiers of the other of the number of transmission chains in which the commutator 800 is included are in the off state (i.e., one of the EE operation modes of the base station takes place), then, by setting the switch subsystem 802 to the respective distributing state of switches and accordingly employing the power divider subsystem 801, signals incoming to the one or more inputs of the commutator are forwarded to all the outputs of the commutator, while distribution of power of the incoming signals is carried out over all the outputs of the commutator by means of the power divider subsystem 801. As a result, even when some of power amplifiers are turned off, all subarrays are used for DL transmission; accordingly, decrease in the antenna gain and the associated negative effects are avoided which are typical to the both AM options in 5G NR, as described above with reference to FIGS. 1A, 1B, 2A, and 2B.

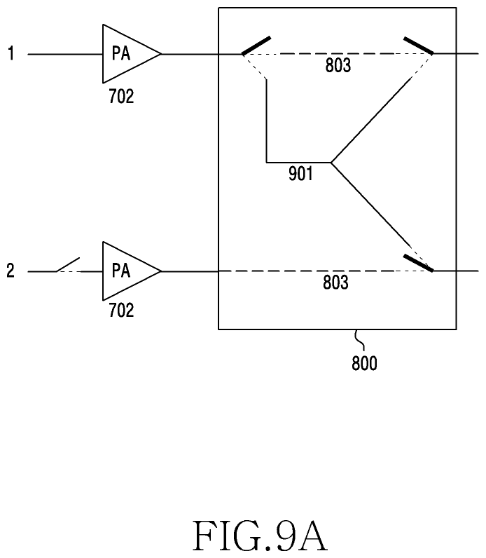

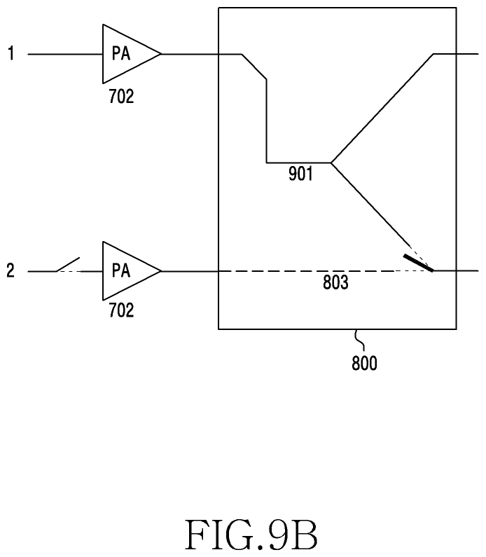

Furthermore, with reference to FIGS. 9A, 9B, and 10 to 13, specific implementations of commutators 800 of the system 703 of commutators of the base station transmitting apparatus 700 are disclosed.

FIGS. 9A and 9B illustrate the commutator according to various embodiments of the disclosure.

Referring to FIG. 9A each commutator 800 is included in two neighboring transmission chains, the power divider subsystem 801 of the commutator is represented by one power divider 901. Both outputs of the power divider 901 are connected, via respective output switches, to both outputs of the commutator 800, and the input of the power divider 901 is connected, via an input switch, to one of two inputs of the commutator 800 (in particular, to the commutator input connected to transmission chain 1 in FIG. 9A). As a result, the switch subsystem 802 of the commutator has one distributing state in which the power divider 901 is in the connected state and both pass-through lines 803 of the commutator 800 are in the disconnected state.

In the considered implementation according to FIG. 9A, when the power amplifier 702 of transmission chain 1 is in the on state and the power amplifier 702 of transmission chain 2 is in the off state (i.e., the EE operation mode of the base station takes place) and, accordingly, the switch subsystem 802 is in the distributing state, a signal from the power amplifier of transmission chain 1 is forwarded by the power divider 901 towards both outputs of the commutator, along with accordingly distributing power of the signal being forwarded. In the considered implementation, there is one EE mode in which half of the base station power amplifiers are inactive. Furthermore, the switch subsystem 802 can be transitioned to the pass-through state, and signals from the power amplifiers 702 of transmission chains 1 and/or 2 will be directly sent, along the respective pass-through lines 803, towards the outputs of these transmission chains.

In the considered implementation, the commutator 800 can be included in more than two transmission chains, and in this case, in the EE mode, a signal from one input of the commutator will be similarly forwarded towards all the outputs of the commutator 800.

The RSA according to the disclosure provides flexible configurability and, accordingly, supports various options of arranging commutators and/or power dividers within the system 703 of commutators to optimize support of the required EE modes of the base station.

In particular, the system 703 of commutators can comprise more than one level of commutators, and in this case the levels of commutators will be located sequentially one after another, in such a way that inputs of each commutator of a subsequent level of commutators will be connected to outputs of commutators of a preceding level of commutator.

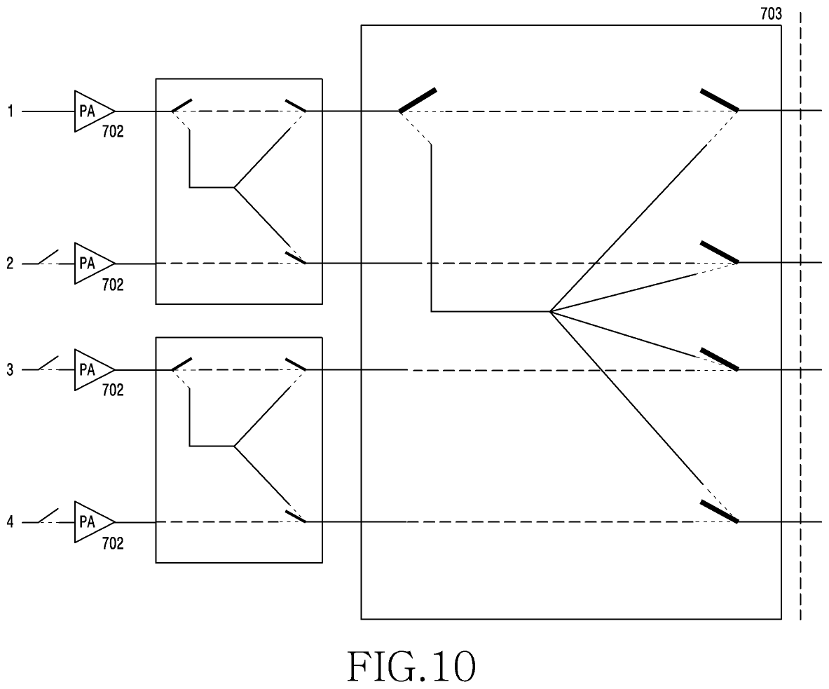

FIG. 10 shows an illustrative implementation in which the system 703 of commutators comprises two levels of commutators according to an embodiment of the disclosure.

Referring to FIG. 10, each of the commutators of the first level is similar to the commutator according to the implementation of FIG. 9A and is accordingly included in two neighboring transmission chains. Outputs of the two commutators of the first level are connected to four inputs of the commutator of the second level, that is, the commutator of the second level is therefore included in four neighboring transmission chains.

In the considered implementation, two EE operation modes of the base station are provided for.

In one EE mode, as in the implementation of FIG. 9A, half of the power amplifiers are inactive; in this case, in the considered implementation, it is assumed that signals are provided to the illustrated part of the system 703 of commutators only from transmission chain 1 and transmission chain 3 in which respective power amplifiers are active. In this EE mode, the switch subsystem of each of the commutators of the first level will be in the distributing state and the switch subsystem of the commutator of the second level will be in the pass-through state. Embodiment of this EE mode in the implementation in FIG. 10 is basically similar to the one according to FIG. 9A.

In the other EE mode, three quarters of the power amplifiers are inactive; in this case, in the considered implementation, it is assumed that a signal is provided to the illustrated part of the switching system only from transmission chain 1 in which the respective power amplifier is active. In this EE mode, the switch subsystem of each of the commutators of the first level will be in the pass-through state and the switch subsystem of the commutator of the second level will be in the distributing state; therefore, the signal provided to the input of the second level commutator which is included in transmission chain 1 will be forwarded to all the four outputs of the commutator, along with respectively distributing power of the signal being forwarded. Even when ¾ of power amplifiers are turned off, the architecture provided according to the first aspect of the disclosure enables to perform transmission from all subarrays of the antenna array.

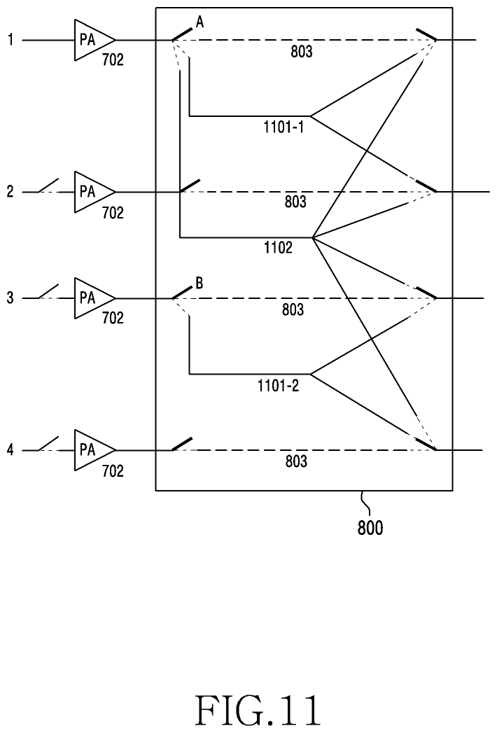

FIG. 11 illustrates a more preferred implementation where, in a power divider subsystem of a commutator, there are two or more power dividers which can be implemented in one or more power divider levels according to an embodiment of the disclosure.

Referring to FIG. 11, each commutator 800 is included in four neighboring transmission chains (respectively denoted as transmission chains 1, 2, 3, 4 in this figure), and the power divider subsystem 801 of the commutator comprises two power divider levels, where the first power divider level comprises two power dividers 1101-1, 1101-2, and the second power divider level comprises one power divider 1102.

Each power divider of the first level has one input and two outputs. An input of the power divider 1101-1 is connected, via an input switch A, to an input of the commutator 800 in transmission chain 1, and outputs of the power divider 1101-1 are connected, via respective output switches, to outputs of the commutator in transmission chains 1 and 2. In a similar way, an input of the power divider 1101-2 is connected, via an input switch B, to an input of the commutator 800 in transmission chain 3, and outputs of the power divider 1101-2 are connected, via respective output switches, to outputs of the commutator in transmission chains 3 and 4. Therefore, the outputs of the power dividers of the first level are connected to all the four outputs of the commutator 800. The power divider 1102 of the second level has one input and four outputs. The input of the power divider 1102 is connected, via the input switch A, to the input of the commutator 800 in transmission chain 1, and the outputs of the power divider 1102 are one-to-one connected, via the respective output switches, to all the four outputs of the commutator.

In the implementation illustrated in FIG. 11, the switch subsystem 802 of the commutator 800 has two distributing states of switches. In the first distributing state, the power dividers 1101-1, 1101-2 of the first level are in the connected state, and the power divider 1102 of the second level is in the disconnected state; in particular, the multi-position input switch A at the input of the commutator in transmission chain 1 is switched to the position that connects the power divider 1101-1 and at the same time disconnects the power divider 1102 and the respective pass-through line 803. In the second distributing state, the power divider 1202 of the second level is in the connected state and the power dividers 1101-1, 1101-2 of the first level are in the disconnected state; in particular, the input switch A at the input of the commutator in transmission chain 1 in this case is switched to the position that connects the power divider 1102 and at the same time disconnects the power divider 1101-1 and the respective pass-through line 803.

In the considered implementation, at least two EE modes of the base station are possible.

In one EE mode, half of the power amplifiers are inactive; in such a case, in this implementation it is assumed that signals are provided to the commutator 800 only from transmission chain 1 and transmission chain 3 in which the respective power amplifiers are active. In this EE mode, the switch subsystem of the commutator 800 will be in the first distributing state. Thus, the signals from the power amplifiers of transmission chains 1, 3 will be respectively forwarded by the power dividers 1101-1, 1101-2 to the four outputs of the commutator 800, whereas the power divider 1102 is not used.

In the other EE mode, three quarters of the power amplifiers are inactive; in this case it is assumed that a signal is provided to the commutator 800 only from transmission chain 1 in which the respective power amplifier 702 is active. In this EE mode, the switch subsystem of the commutator 800 will be in the second distributing state. Thus, the signal from the power amplifier of transmission chain 1 will be forwarded only by the power divider 1102 of the second level to all the four outputs of the commutator 800, along with respectively distributing power of the signal being forwarded.

As in the implementations described above, when the power amplifiers of all four transmission chains 1-4 are in the on state (for example, the primary operation mode of the base station takes place), the switch subsystem 802 of the commutator 800 will be in the pass-through state of switches and, therefore, a signal from the power amplifier 702 of each of the chains 1-4, which is provided to a respective input of the commutator 800, will be directed to a respective output of the commutator via the pass-through line 803.

It should be appreciated that, in the implementation considered with reference to FIG. 11, the commutator 800 may be included in a greater number of transmission chains and, accordingly, comprise a greater number of power dividers and/or a greater number of power divider levels. In general, for the multi-level arrangement of the power divider subsystem 801 of the commutator 800, the number of outputs of any power divider in each power divider level is the same, and outputs of power dividers in each power divider level are one-to-one connected to all outputs of the commutator 800; in each subsequent power divider level, the number of power dividers is respectively less than the number of power dividers in a preceding power divider level, and the number of outputs of a power divider in each subsequent power divider level is respectively greater than the number of outputs of a power divider in a preceding power divider level. It should be also appreciated that this implementation may provide for more flexible states of switches of the switch subsystem 802, when power dividers from different power divider levels are employed. Furthermore, the disclosure provides for combined usage of commutators according to the implementation of FIG. 9A and according to the implementation of FIG. 11, in particular—in the multi-level arrangement of the system 703 of commutators considered with reference to FIG. 10; moreover, implementations are possible in which, for some of transmission chains in which a commutator(s) is included, the power divider subsystem of the commutator may not be used at all. Therefore, the architecture according to the disclosure is scalable, with the capability to flexibly dynamically or semi-statically switch to a required operation mode of the base station, for example, depending on network traffic load.

It is also necessary to emphasize that the implementations considered above with reference to FIGS. 8, 9A, 9B, 10, and 11 are of illustrative rather than restrictive nature. For instance, a commutator does not have to be included exclusively in neighboring transmission chains of the base station transmitting apparatus. Furthermore, embodiments of the required signal switching and the respective power distribution of the switch subsystem and/or power dividers may be different from the considered implementations. For example, FIG. 9B shows the implementation of the commutator which is alternative to the commutator of FIG. 9A, providing similar signal switching. As seen from FIG. 9B, in this implementation of the commutator 800, input switches and an output switch at the output of the commutator 800, which is included in transmission chain 1, are absent. Accordingly, there is only the output switch at the output of the commutator 800, which is included in transmission chain 2, and this output switch provides either connection of the respective output of the power divider 901 along with disconnecting the pass-through line 803, thereby implementing the distributing state, or connection of the pass-through line 803 along with switching off the respective output of the power divider, thereby implementing the pass-through state. In this pass-through state, the power divider line extending to the output of the commutator 800 in transmission chain 1 will act as a pass-through line for the transmission chain. Then, in a number of implementations of the switch subsystem 802, input switches may be present at each input of the commutator. Such alternative implementations should be clear to a skilled artisan, and this aspect does not impose limitations onto the disclosure. In addition, the disclosure provides for implementations in which the power divider subsystem and/or the switch subsystem of a commutator(s) may have states that cause not applying a signal to part of outputs of the commutator; thus, the application envisages a combination of the RSA based approach according to the disclosure, as described above, with the 5G NR approach based on AM, in one base station transmitting apparatus.

As discussed in detail earlier, usage of the RSA according to the disclosure in the base station transmitting apparatus, the implementations of which have been illustrated above with reference to FIGS. 7, 8, 9A, 9B, 10, and 11, enables to perform DL transmission from all subarrays of the antenna array in any of EE modes of the base station; accordingly, by summing signals from all the subarrays, it is possible to obtain substantially the same antenna gain as in the primary mode. This is a significant difference from 5G NR where, when using the AM technology, in addition to reduced power consumption, there is also decrease in the antenna gain.

It is necessary to note the following herein. A scheduler of the base station can schedule DL transmission, while beamforming (D-BF) is carried out by the scheduler separately for the primary mode operation of the base station, in which all transmission chains of the transmitting apparatus are active, and each of the EE modes, where part of the transmission chains is respectively deactivated due to turning off part of power amplifiers. Then, considering expected spectral efficiency of the transmission, which is to be determined based on feedback (CSI) from a user equipment(s), and power consumption in each of the modes, the currently best mode is selected therefrom. D-BF digital weights enable to control phase and amplitude of each subcarrier of signals transmitted from one or more subarrays connected to each DAC of a respective transmission chain.

At the same time, in an EE mode, due to the partial deactivation of transmission chains, the respective part of digital signals will not be transmitted. Although usage of the RSA according to the disclosure maintains all subarrays of the antenna array in the active state, nevertheless, in the EE mode, the same signal will be transmitted from several subarrays. For instance, in the implementation shown in FIG. 9A or 9B, the same signal, which has been provided from the same DAC of transmission chain 1, will be transmitted from the two respective subarrays. Thus, the number of degrees of freedom for beamforming in the EE mode is significantly reduced along with decrease in the number of DACs being used. As a result, beamforming for the scheduled DL transmission to be performed in the EE mode may become suboptimal; in other words, there may be an undesirable loss of control of directionality. The decrease in the expected spectral efficiency due to the less optimal beamforming causes the base station scheduler to choose the EE mode less often for DL transmission.

In order to, at least partially mitigate this issue, which relates to the possible loss of control of directionality in a EE operation mode of the base station, in a preferred embodiment of the RSA, a phase shifter is additionally included in each of at least some of the number of transmission chains into which the commutator 800 is included (see FIG. 8), the phase shifter being placed directly at the output of the transmission chain, i.e. directly before the respective subarray.

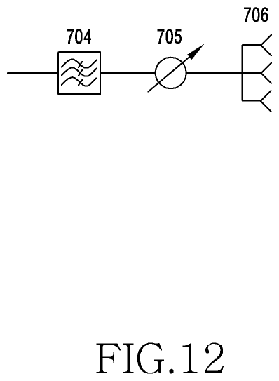

FIG. 12 illustrates inclusion of phase shifters 705 for parts of the transmission chains highlighted by dashed contours in FIG. 7 according to an embodiment of the disclosure.

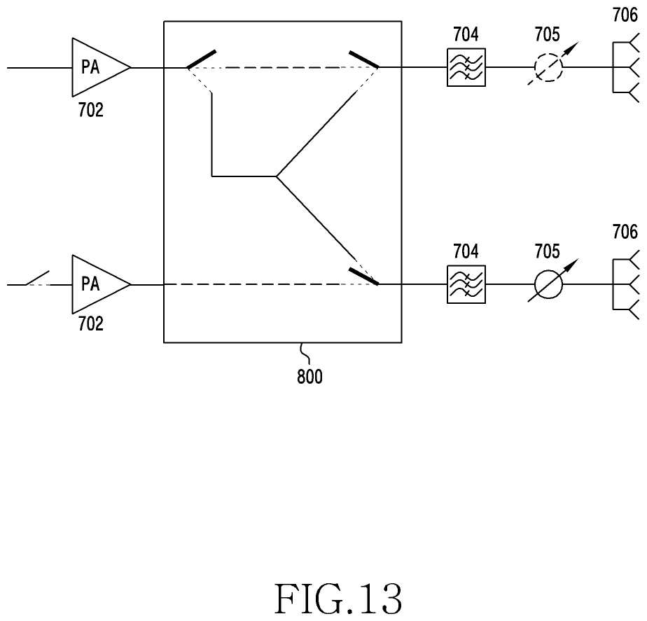

FIG. 13 illustrates inclusion of a phase shifter(s) for the implementation of the commutator according to FIG. 9A according to an embodiment of the disclosure.

Referring to FIGS. 12 and 13, the main purpose of the phase shifters 705 included in the transmission chains whereto the commutator is connected is to set the phase shifters to such preset values which would provide a phase shift between signals transmitted from the respective subarrays, in order to carry out required beamforming (A-BF).

Usage of a phase shifter enables, for each of a number of subarrays for which the same DAC is used at the input in an EE mode, to set a common phase shift of all subcarriers (while amplitude control and individual phase control of each subcarrier remain impossible). Therefore, the number of degrees of freedom for beamforming in the EE mode increases, thereby allowing, though not reaching the level of the primary mode, to significantly mitigate the negative effects due to the loss of control directionality in the EE mode, as described above. The respective increase in spectral efficiency of transmission in the EE mode allows the base station scheduler to choose this mode more often. It should be noticed that, according to a preferred practical implementation, sets of shifts in phase shifters of such a number of subarrays, which are connected to each one DAC in the EE mode, coincide and are selected from a predefined A-BF codebook.

In order to ensure required phase shifts, phase shifters 705 can be added to all or not all transmission chains in which the commutator is included; this aspect does not impose limitations onto the disclosure. In FIG. 13 this aspect is illustrated by the dashed image of the phase shifter for transmission chain 1. The same phase shift between two transmitted signals can be provided both by one phase shifter in transmission chain 2 and by two phase shifters in the two transmission chains.

In the primary operation mode of the base station, phase shifters 705 are preferably not used.

Thus, according to the disclosure, D-BF and/or A-BF can be used to control the direction of DL transmission, depending on the base station operation mode.

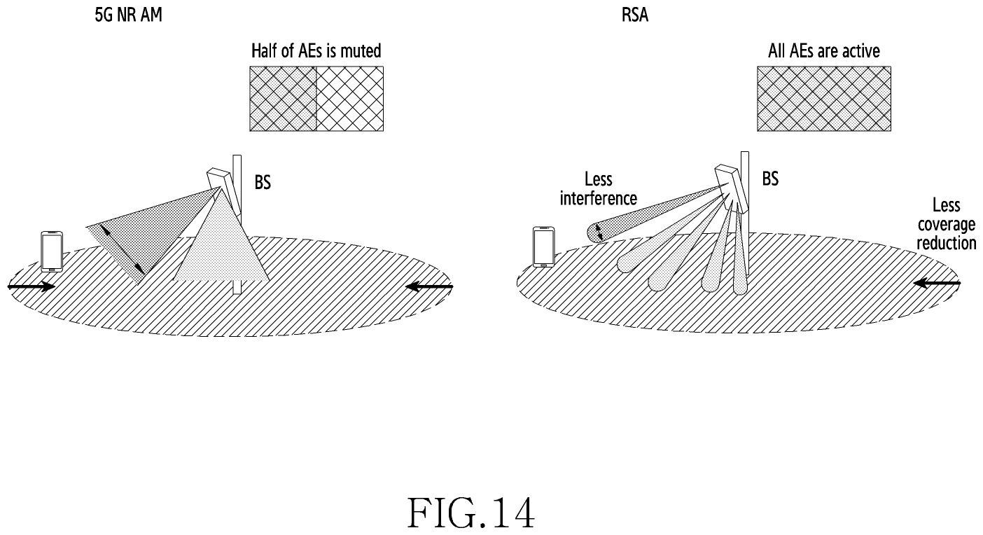

FIG. 14 illustrates the advantages over 5G NR provided by the architecture in an EE mode according to an embodiment of the disclosure.

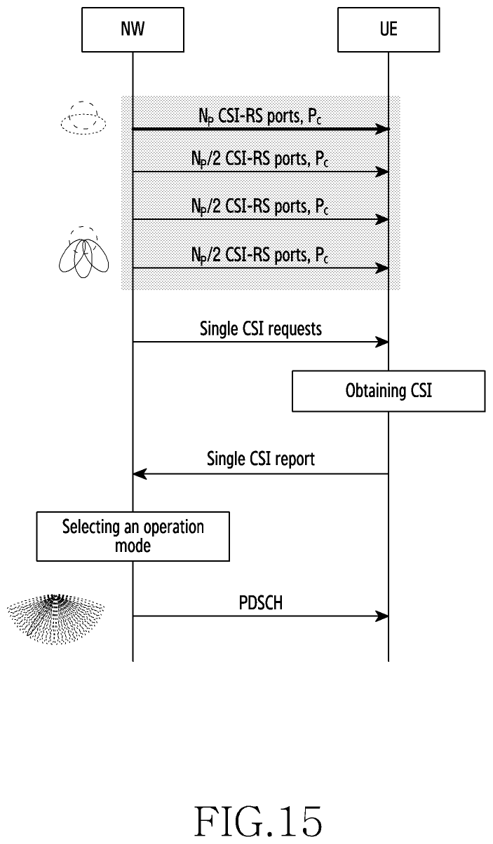

Thereafter, with reference to FIGS. 15, 16A, 16B, 16C, 17A, 17B, and 18, the description is given with respect to configuring CSI-RS transmission, as well as accordingly receiving and reporting CSI for the case of using the RSA according to the disclosure.

In the disclosure, similarly to the above disclosure in relation to 5G NR with reference to FIG. 1A, one or more subarrays are virtualized into a respective CSI-RS port having its own individual CSI-RS associated therewith. In particular, when transmitting CSI-RSs for an EE mode, several subarrays are virtualized into one CSI-RS port. As noted earlier, the number of active DACs in respective transmission chains and the scheme of connecting subarrays thereto differ for different base station operation modes, including the primary mode and each of the EE modes (see, e.g., the disclosure of FIGS. 9A, 9B, 10, and 11 above). Therefore, subarrays should be virtualized into CSI-RS ports differently to obtain CSI corresponding to DL data transmission in each of these modes. In order to take a decision regarding certain switching between the primary mode and EE modes, the base station should have available CSI obtained and reported by a user equipment(s) based on measurements of CSI-RSs transmitted separately for each of the base station operation modes. Accordingly, respective CSI-RS resources and/or CSI-RS resource sets should be defined in the base station and signaled in advance to the user equipment. The mechanism itself for configuring CSI-RS resources or CSI-RS resource sets for user equipment by means of RRC signaling is similar to the one which is used in 5G NR and has been outlined above when describing the prior art.

Therefore, for a UE, one CSI-RS resource set is configured for the primary operation mode of the base station, and one or more CSI-RS resource sets are configured for respective one or more EE modes. Each j-th CSI-RS resource set from the one or more CSI-RS resource sets comprises Nᵣₛᵣ^{(j)} CSI-RS resources, Nᵣₛᵣ^{(j)}≥1, where Nsr, in general, can be different for different CSI-RS resource sets; in other words, the number of CSI-RS resources in each of the CSI-RS resource sets can be configured in the base station individually for the CSI-RS resource set. Each CSI-RS resource set from the one or more CSI-RS resource sets for the EE modes corresponds to a different configuration of the on and off states of power amplifiers of the transmitting apparatus and/or states of switches of commutators of the transmitting apparatus (see the disclosure according to FIGS. 9A, 9B, 10, and 11 above); moreover, in accordance with the aforesaid, the configuration respectively defines the number of CSI-RS ports of a CSI-RS resource in this CSI-RS resource set for subsequent DL data transmission. For example, a CSI-RS resource set(s) can be configured for the EE mode described with reference to FIGS. 9A and 9B or for the one EE mode described with reference to FIG. 10 in which half of power amplifiers of the base station transmitting apparatus are deactivated, and/or a CSI-RS resource set(s) can be configured for the EE mode described with reference to FIG. 11 or for the other EE mode described with reference to FIG. 10 where three quarters of the power amplifiers are deactivated. Therefore, at least in two CSI-RS resource sets from the CSI-RS resource sets configured for the user equipment according to the considered embodiment, the number of CSI-RS ports of the CSI-RS resource will be different.

The CSI-RS resource set for the primary operation mode of the base station comprises one CSI-RS resource which corresponds to DL data transmission when all power amplifiers of the base station transmitting apparatus are in the on state. Thereafter in the text of the specification and in the drawings the one CSI-RS resource can be referred to without limitations as the nPC (non-precoded) CSI-RS resource. Then, in at least some or all of the one or more CSI-RS resource sets configured for the EE modes: NY CSI-RS resources of a j-th CSI-RS resource set correspond to DL data transmission with beamforming with respective usage of phase shifters of the base station transmitting apparatus (see the disclosure of FIGS. 12 and 13 above); in this case, each CSI-RS resource of the Nᵣₛᵣ^{(j)} CSI-RS resources preferably corresponds to one set of phase shift values from the aforementioned A-BF codebook which should be accordingly applied during DL data transmission in a respective j-th EE operation mode of the base station. This configuring of CSI-RS resource sets for EE modes is basically similar to the configuring of CSI-RS resources for different A-BF beams illustrated in general in FIG. 4. Thereafter in the text of the specification and in the drawings, CSI-RS resources from such at least some CSI-RS resource sets can be referred to without limitations as PC (precoded) CSI-RS resources. The disclosure also provides for an implementation in which, when transmitting some PC CSI-RS resource(s), all power amplifiers of the transmitting apparatus will be active (for example, to increase signal-to-noise ratio at the user equipment receiver and, accordingly, for more accurate DL channel estimation); in such an implementation, transmission of the CSI-RS resource can be done without directly carrying out A-BF, but by emulating respective set of A-BF phase shifts in D-BF weights. It is necessary to emphasize that this possible implementation relates only to CSI-RS transmission, and subsequent DL data transmission in a respective EE mode will be done with directly carrying out A-BF, as recited above, and with deactivation of the respective part of power amplifiers.

FIG. 15 illustrates, in a format similar to FIGS. 3, 5A, and 5B, the generalized scheme of interaction between a wireless communication network (NW) and a user equipment (UE) for the preferred embodiment of the disclosure indicated in the previous paragraph according to an embodiment of the disclosure.

Referring to FIG. 15, as noted in relation to the disclosure according to FIGS. 5A and 5B, in 5G NR, for each of CSI-RS resources or CSI-RS resource sets corresponding to the primary and EE operation modes of the base station, a respective separate CSI request is to be transmitted from the base station to the user equipment. According to the second aspect of the disclosure, one CSI request transmitted via DCI comprises, at least, an indication of two or more CSI-RS resources from different CSI-RS resource sets among the CSI-RS resource sets configured for the user equipment. In other words, for all the CSI-RS resources of interest with respect to which the base station requires a CSI report for beamforming for subsequent DL data transmission, the base station transmits a single CSI request to the user equipment.

Referring to FIG. 15, the CSI request comprises an indication of (i) the nPC CSI-RS resource (the primary mode, all Nₚ CSI-RS ports are active) and (ii) a set of three PC CSI-RS resources (the EE mode, Nₚ/2 CSI-RS ports are active (see, e.g., FIGS. 9A and 9B), wherein each of the three PC CSI-RS resources corresponds to DL data transmission with different beamforming (A-BF) by accordingly using phase shifters (see the disclosure of FIGS. 12 and 13) of the base station transmitting apparatus. It should be noticed that the illustrated single CSI request comprises the indication of CSI-RS resources with a different number of CSI-RS ports.

The base station transmits CSI-RSs for all the CSI-RS resources indicated in the CSI request for the user equipment. The base station will perform transmissions of CSI-RSs for the nPC CSI-RS resource, as well as for each of the PC CSI-RS resource set in a respective A-BF direction. For each of the CSI-RS transmissions, the user equipment should perform measurements of respective CSI-RSs, obtain respective CSI, and report it to the base station, so that the base station, when scheduling subsequent DL data transmission (e.g., PDSCH) to the user equipment, has comprehensive information for taking a decision not only regarding whether to carry out this data transmission in the primary or EE mode, but also regarding which A-BF beamforming to use in the DL transmission in the case of the EE mode.

According to the second aspect of the disclosure, a combination of bit values is predefined in the base station, and this combination of bit values is signaled in advance from the base station to the user equipment via RRC signaling. The abovementioned single indication of the two or more CSI-RS resources is implemented by selecting, by the base station, a respective bit value from at least part of the predefined combination of bit values and embedding the bit value into a respective CSI request bit field.

Tables 1 and 2 provide non-limiting examples of implementation of a code table in which respective indications of CSI-RS resources in the CSI request are encoded by means of bit values. Table 1 is given for the case where values of the DCI bit field have length of 2 bits; Table 2 is given for the case where values of the DCI bit field have length 3 bits.

TABLE 1

| DCI CSI request | |
|---|---|
| bit field value | for which CSI-RS resources CSI is requested |
| 00 | CSI not requested |
| 01 | nPC CSI-RS resource |
| 10 | K = 1 selected PC CSI-RS resource from the PC |
| | CSI-RS resource set (selection of one A-BF beam) |
| 11 | [nPC CSI-RS resource] + [K = 1 selected |
| | PC CSI-RS resource from the PC CSI-RS resource set] |

TABLE 2

| DCI CSI request | |
|---|---|
| bit field value | for which CSI-RS resources CSI is requested |
| 000 | CSI not requested |
| 001 | nPC CSI-RS resource |
| 010 | 1^{st} PC CSI-RS resource from the PC CSI-RS |
| | resource set (1^{st} A-BF beam) |
| 011 | 2^{nd} PC CSI-RS resource from the PC CSI-RS |
| | resource set (2^{nd} A-BF beam) |
| 100 | 3^{rd} PC CSI-RS resource from the PC CSI-RS |
| | resource set (3^{rd} A-BF beam) |
| 101 | K = 1 selected PC CSI-RS resource from the PC |
| | CSI-RS resource set (selection of one A-BF beam) |
| 110 | K = 2 selected PC CSI-RS resources from the PC |
| | CSI-RS resource set (selection of two A-BF beams) |
| 111 | [nPC CSI-RS resource] + [K = 1 selected PC |
| | CSI-RS resource from the PC CSI-RS resource set] |

Accordingly, a code table similar to Table 1 or Table 2 is set in the base station and sent in advance to a user equipment(s) via RRC signaling. In Tables 1 and 2, each bit value (except the one that encodes ‘CSI is not requested’) indicates one or more CSI-RS resources for each of which the user equipment is to determine the respective parameters, including RI, PMI, CQI, for reporting to the base station in the CSI report. The implementation according to Table 2 is associated with greater bit load onto DCI, but provides greater flexibility in indicating CSI-RS resources for the user equipment.

Based on the value of the bit field comprised by the received DCI CSI request, the user equipment determines, according to its code table, with respect to what number of CSI-RS resources CSI should be obtained and from which CSI-RS resource set(s) these CSI-RS resources to be reported are.

In the considered context code tables defining bit values of length greater than 2 or 3 bits can be used in a similar way, if required; this aspect does not impose limitations onto the disclosure.

Upon reception of the CSI request comprising the value of the considered bit field, for example, ‘10’ in the case of Table 1 or ‘101’ in the case of Table 2, the user equipment will have to select one PC CSI-RS resource from the configured CSI-RS resource set to report the CSI. This selection can be made based on measuring received power of respective CSI-RSs, and accordingly one CSI-RS resource will be selected which has the largest measured received power corresponding thereto, or, more preferably, based on predicted values of spectral efficiency of respective DL data transmissions, and accordingly one CSI-RS resource will be selected which has the largest spectral efficiency value corresponding thereto.

Upon reception of the DCI in which the value of the CSI request bit field indicates inter alia to select a target number of CSI-RS resources from a respective CSI-RS resource set, the user equipment can select, for generating the CSI report, CSI-RS resources in a number less than the indicated target number of CSI-RS resources.

For example, by means of the CSI request comprising the DCI bit field value equal to ‘110’ in the case of Table 2, the user equipment is instructed by the base station to select two PC CSI-RS resources from the configured CSI-RS resource set. At the same time, the user equipment, based on results of respective measurements and/or estimations, can determine that only one PC CSI-RS resource from the three PC CSI-RS resources of the set has appropriate DL channel quality corresponding thereto. Accordingly, the user equipment can decide to report, to the base station, CSI only in relation to this one PC CSI-RS resource.

As recited in relation to the disclosure of FIGS. 5A and 5B, in 5G NR, for each one CSI-RS resource being reported, a respective separate CSI report is to be transmitted from the user equipment to the base station.

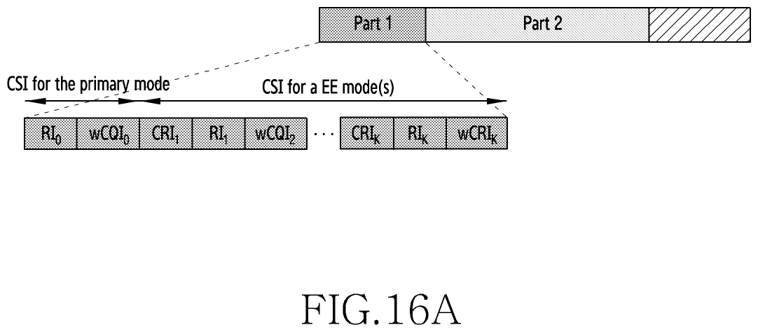

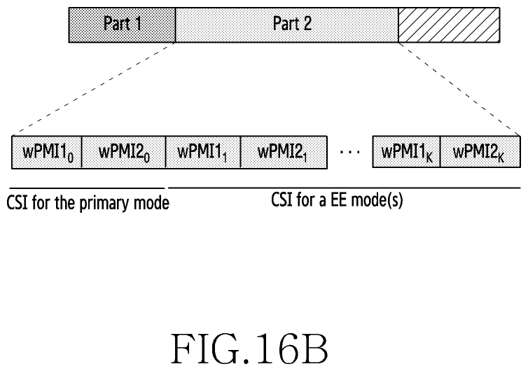

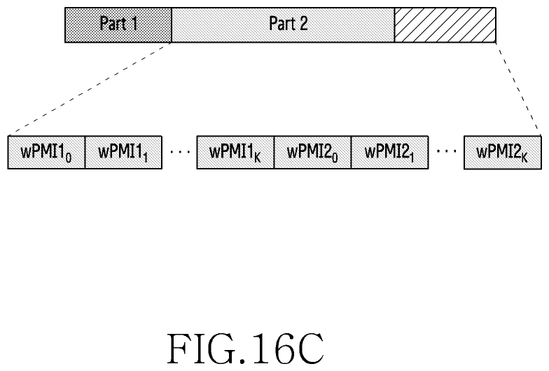

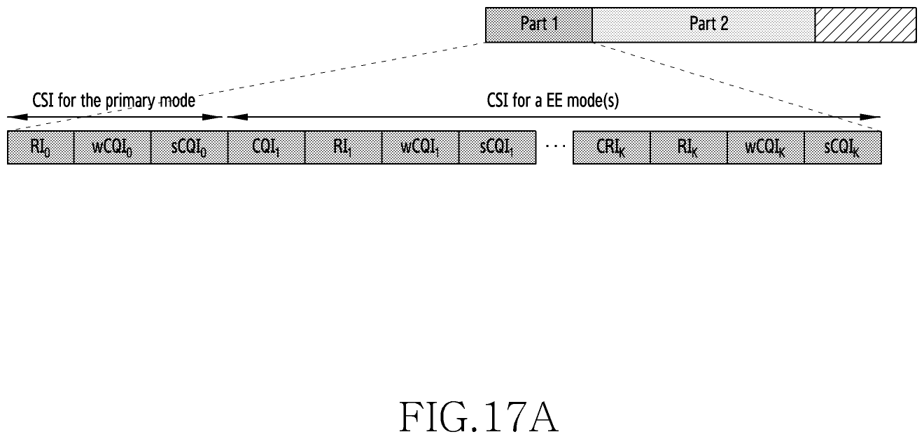

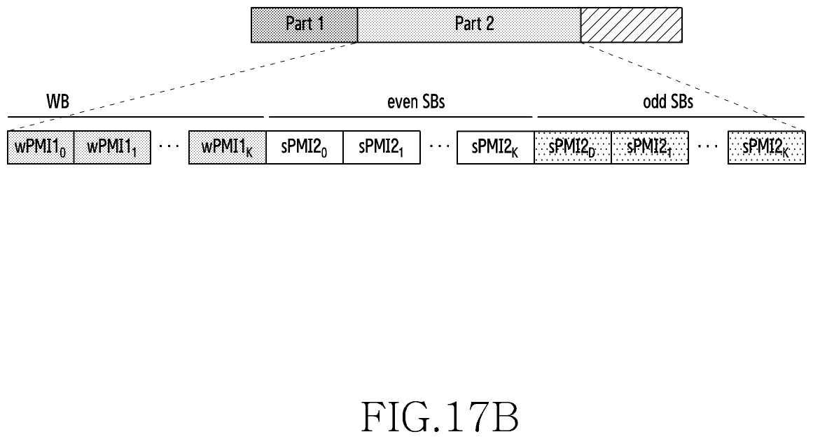

FIGS. 16A, 16B, 16C, 17A, and 17B illustrate channel state information (CSI) parameters arrangement within uplink control information (UCI) according to various embodiments of the disclosure

Referring to FIGS. 16A, 16B, 16C, 17A, and 17B, single reporting, to the base station, of CSI obtained in the user equipment with respect to several CSI-RS resources is described according to illustrative embodiments of the second aspect of the disclosure. Moreover, calculation itself in the user equipment of RI, PMI, CQI for each of the CSI-RS resources to be reported (‘obtaining CSI’ in FIG. 15) does not directly relate to the subject of the disclosure, and, accordingly, any suitable technologies can be used for the calculation (e.g., at least partially, the ones accordingly applied in 5G NR).

In the considered embodiments, as in 5G NR, CSI is transmitted via UCI the UL transmission of which is pre-scheduled in the base station. Two parts are allocated in UCI for transmission of the CSI: CSI part 1 with a fixed payload size (in bits) and CSI part 2 with a payload size that can be variable, while the payload size of CSI part 2 depends on contents of CSI part 1. Parameters comprised by the CSI are accordingly distributed over CSI part 1 and CSI part 2 within UCI. In this case, payload of CSI part 2 can be obtained in the base station only after decoding payload of CSI part 1.

Moreover, the omission mechanism is provided for CSI part 2, and, according to the mechanism, if the total payload of CSI parameters exceeds the payload size initially allocated by the base station when scheduling transmission of CSI part 2, then some of the CSI parameters intended for being placed into CSI part 2 are excluded from the transmitted UCI to match the allocated size. To implement the omission mechanism, the CSI parameters are ordered in CSI part 2 within UCI in such a way that parameters that are less important for operation of the system are placed to the end of CSI part 2.

The UCI transmission itself can be carried out in the physical level (L1) or MAC level (L2).

Application of the UCI-based approach to CSI transmission, as outlined above, is also planned in 6G xMIMO systems.

Consideration of the implementations according to FIGS. 16A, 16B, 16C, 17A, and 17B is conducted in continuation of the disclosure of the second aspect of the disclosure (see the upper part of FIG. 15), where one nPC CSI-RS resource and one or more PC CSI-RS resources from the PC CSI-RS resource set (see Tables 1, 2) are indicated to the user equipment by means of the CSI request bit field in the DCI.

For the nPC CSI-RS resource, the CSI parameters to be reported, which are calculated in the user equipment, are respective RI, CQI, and PMI. It should be noted that since this CSI-RS resource is a single CSI-RS resource, its CRI is not required at the base station; accordingly, the CSI report preferably does not include CRI for the nPC CSI-RS resource.

For any PC CSI-RS resource from the indicated CSI-RS resource set, the CSI parameters to be reported are respective RI, CQI, and PMI, as well as CRI of the PC CSI-RS resource, so that the base station can identify from the received CSI for which CSI-RS resource from the PC CSI-RS resource set configured for the user equipment the RI, CQI, PMI are reported.

As recited earlier when describing the background art, PMI is represented in the CSI by two parameters: PMI1 and PMI2.

In this case, for the described illustrative implementations, without limitations, it is assumed that the total number of CSI-RS resources for which the CSI is reported is equal to M, where M≥2.

FIG. 16A illustrates the implementation of filling CSI part 1 for the case where CSI comprises a wideband report (WB report) according to an embodiment of the disclosure, and FIGS. 16B and 16C respectively illustrate the first and second implementations of filling CSI part 2 for the case where the CSI comprises the WB report according to various embodiments of the disclosure.

Respective CSI parameters relating to the context of the WB report are marked in the text and in the figures of the application by symbol ‘w’.

Referring to FIG. 16A, the set {RI₀, wCQI₀} for the nPC CSI-RS resource is included in CSI part 1, and, after the set {RI₀, wCQI₀}, the sequence of sets {CRIᵢ, RIᵢ, wCQIᵢ} for the PC CSI-RS resources being reported, where 1≤i≤M−1. As one example, if the DCI CSI request received by the user equipment comprised the bit value ‘111’ according to Table 2 (accordingly, M=2), then the sequence will be represented by one set {CRI₁, RI₁, wCQI₁} for one selected PC CSI-RS resource.

Referring to FIG. 16B, the set {wPMI1₀, wPMI2₀} for the nPC CSI-RS resource is included in CSI part 2, and, after the set {wPMI1₀, wPMI2₀},—the sequence of sets {wPMI1ᵢ, wPMI2ᵢ} for the selected PC CSI-RS resources, where 1≤i≤M−1. At the same time, the sequence of sets {wPMI1₁, wPMI2ᵢ} is ordered in CSI part 2 according to the ordering of {CRIᵢ} in CSI part 1. In continuation of the one example, this sequence will again be represented by one set {wPMI1₁, wPMI2₁} for one selected PC CSI-RS resource.

As another example, if the DCI CSI request received by the user equipment comprised the bit value ‘110’ according to Table 2, then the CSI report will comprise CSI parameters only for two reported PC CSI-RS resources selected in the user equipment from the configured PC CSI-RS resource set. In this case, the abovementioned sequence in CSI part 1 will be represented by two sets {CRI₁, RI₁, wCQI₁}, {CRI₂, RI₂, wCQI₂} for two selected PC CSI-RS resources, where these sets are preferably ordered in CSI part 1 according to a metric according to which the selection of reported PC CSI-RS resources was carried out. For example, a PC CSI-RS resource with the highest received power or the highest spectral efficiency can correspond to the set {CRI₁, RI₁, wCQI₁}. Accordingly, the sequence in CSI part 2 will be represented by two sets {wPMI1₁, wPMI2₁}, {wPMI1₂, wPMI2₂}.

Referring to FIG. 16C, the sequence {wPMI1ᵢ} is included in CSI part 2, the sequence being followed by the sequence {wPMI2ᵢ}, where 0≤i≥M−1. In the considered implementation, wPMI1₀ and wPMI2₀ are for the nPC CSI-RS resource; {wPMI1ⱼ}, following wPMI1₀, and {wPMI2ⱼ}, following wPMI2₀, are respectively for the PC CSI-RS resources being reported, where 1≤j≤M−1; {wPMI1ⱼ}, {wPMI2ⱼ} are respectively ordered according to the ordering of {CRIⱼ} in CSI part 1.

FIG. 17A illustrates the implementation of filling CSI part 1 for the case where CSI additionally comprises a sub-band report (SB report) according to an embodiment of the disclosure, and FIG. 17B accordingly illustrates the implementation of filling CSI part 2 for the case where the CSI comprises the SB report according to an embodiment of the disclosure.

Referring to FIGS. 17A and 17B, respective CSI parameters relating to the context of the SB report are marked in the text and in the figures of the application with symbol ‘s’. It should be explained herein that in 5G NR sub-bands refer to frequency blocks into which the entire frequency band, for which CSI is to be obtained, is divided, and each of the frequency blocks is comprised of several adjacent physical resource blocks (PRB).

Referring to FIG. 17A, the set {RI₀, wCQI₀, sCQI₀} for the nPC CSI-RS resource is included in CSI part 1, and, after the set {RI₀, wCQI₀, sCQI₀},—the sequence of sets {CRIᵢ, RIᵢ, wCQIᵢ, SCQIᵢ} for the PC CSI-RS resources reported, where 1≤i≤M−1. As an example similar to FIG. 16A, if the DCI CSI request received by the user equipment comprised the bit value ‘111’ according to Table 2 (accordingly, M=2), then the sequence will be represented by one set {CRI₁, RI₁, wCQI₁, sCQI₁} for one selected PC CSI-RS resource.

Referring to FIG. 17B, the first set {wPMI1ᵢ} is included in CSI part 2, the first set being followed by the second set {sPMI2ᵢ^{(e)}} followed by the third set {sPMI2ᵢ^{(o)}}, where 0≤i≤M−1. In the text of the specification and in the drawings of the application, ‘sPMI2^{(e)}’ denotes sPMI2 for even frequency sub-bands, and ‘sPMI2^{(o)}’ denotes sPMI2 for odd frequency sub-bands. As an explanation, in the context of reducing CSI transmission overhead, parameters corresponding to even or odd sub-bands can be partially discarded, thereby efficiently providing decreased granularity of the CSI report in the frequency domain. In the considered implementation, wPMI1₀, sPMI2₀^{(e)}, sPMI2₀^{(o)} are for the nPC CSI-RS resource; {wPMI1ⱼ} following wPMI1₀, {sPMI2ⱼ^{(e)}} following sPMI2₀^{(e)}, {sPMI2ⱼ^{(o)}} following sPMI2₀^{(o)} are respectively for the PC CSI-RS resources being reported, where 1≤j≤M−1, and {wPMI1ⱼ}, {sPMI2ⱼ^{(e)}}, {sPMI2ⱼ^{(o)}} are ordered in the first, second, and third sets, respectively, according to the ordering of {CRIⱼ} in CSI part 1. In continuation of the example of FIG. 17A, each of the first, second, and third sets will be respectively represented by one element—wPMI1₁, sPMI2₁^{(e)}, sPMI2₁^{(o)}—for the one reported PC CSI-RS resource selected in the user equipment, along with respectively arranging the elements in CSI part 2 according to the considered implementation.

It is necessary to emphasize once again that the embodiments considered above with reference to FIGS. 15, 16A, 16B, 16C, 17A, and 17B have illustrative rather than restrictive nature. In particular, though FIG. 15 shows transmission, in the CSI request, of the indication of one CSI-RS resource set for one EE operation mode of the base station, it should be appreciated by a skilled artisan that the CSI request may contain an indication of a greater number of CSI-RS resource sets for a respectively greater number of EE modes. The same is fair for the CSI report the implementations of which are illustrated with reference to FIGS. 16A, 16B, 16C, 17A, and 17B.

The second aspect of the disclosure, as discussed in detail above, enables to transmit a single CSI request with respect to all CSI-RS resources and/or CSI-RS resource sets for operation modes of the base station of interest, while the number of CSI-RS ports of a CSI-RS resource in different CSI-RS resource sets indicated in the CSI request can be different, and the aspect also enables to transmit a single CSI report with respect to all CSI-RS resources being reported. These capabilities are not supported in 5G NR. In addition, unlike 5G NR, according to this aspect of the disclosure, the user equipment is enabled to report CSI with respect to multiple CSI-RS resources selected from a respective one CSI-RS resource set.

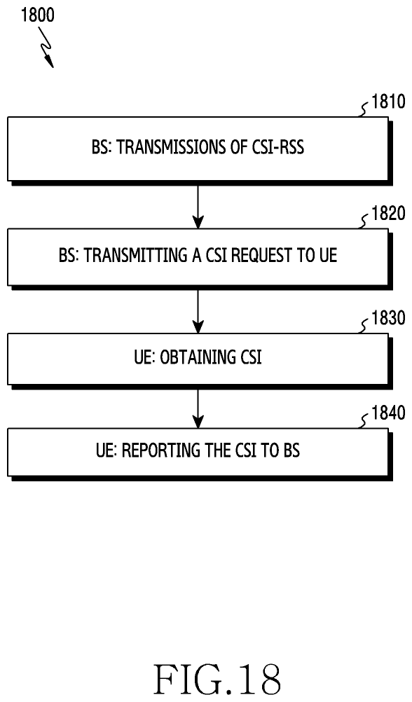

FIG. 18 illustrates a flowchart of a method of obtaining CSI according to an embodiment of the disclosure.

Referring to FIG. 18, a method 1800 is described for obtaining CSI in a wireless communication system comprising a base station (e.g., the BS 602-A, 602-B, 602-C in FIG. 6), the base station comprising a transmitting apparatus according to the first aspect of the disclosure disclosed above with reference to FIGS. 7, 8, 9A, 9B, and 10 to 14.

In operation 1810, CSI-RSs are transmitted from the base station. The CSI-RSs can relate to two or more CSI-RS resource sets from configured CSI-RS resource sets. In accordance with the aforesaid, the two or more CSI-RS resource sets can correspond to different operation modes of the base station, and, in at least two of them, the number of CSI-RS ports of a CSI-RS resource can be different.

In operation 1820, a CSI request is transmitted from the base station to a user equipment, for example, such as the UE 601-1, 601-2, . . . in FIG. 6. The CSI request transmitted via DCI preferably comprises an indication of two or more CSI-RS resources from different CSI-RS resource sets among the two or more CSI-RS resource sets (see the disclosure according to FIG. 15). The implementations of the indication in the DCI CSI request are illustrated in Tables 1, 2 above. As noticed previously, with respect to the indicated CSI-RS resources, the user equipment is substantially requested by the base station to carry out determination of the DL channel state by calculating and reporting the respective CSI parameters.

The transmission of CSI-RSs from different CSI-RS resource sets is evidently not carried out simultaneously; hence, operation 1820 can be performed in parallel with operation 1810 or precede it.

In operation 1830, the user equipment performs calculations to obtain CSI in relation to all or part of the two or more CSI-RS resources which are indicated in the CSI request received in operation 1820. As noticed earlier, the user equipment can select, for reporting to the base station, a number of CSI-RS resources less than indicated in the CSI request. More specifically, for each of the CSI-RS resources to be reported, RI, PMI, CQI are calculated accordingly in the user equipment.

In operation 1840, the user equipment reports the CSI obtained in operation 1830 to the base station. More specifically, a single CSI report is transmitted via UCI, while the implementations of arranging respective RI, PMI, CQI, as well as CRI for certain CSI-RS resources within UCI are discussed in detail above with reference to FIGS. 16A to 16C, 17A, and 17B.

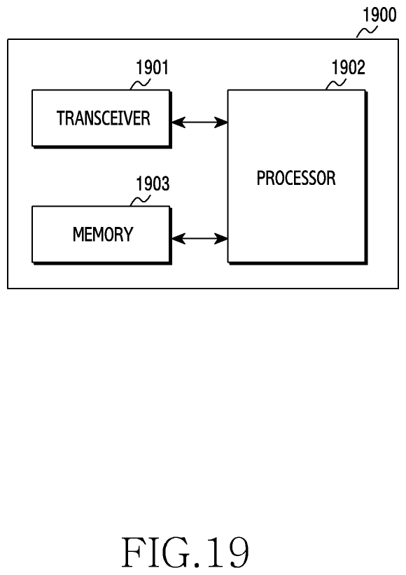

FIG. 19 is a block diagram of a terminal or user equipment (UE) 1900 according to an embodiment of the disclosure.

Referring to FIG. 19, the terminal is an electronic device capable of wireless communication, may include a User Equipment (UE), a portable phone, a smartphone, a tablet, an Internet of things (IoT) device, etc., having various form factors, and may perform wireless communication with a base station (BS) through a wireless channel.

Referring to FIG. 19, the UE 1900 may include at least one transceiver (hereinafter, referred to as simply “transceiver”) 1901, at least one processor (hereinafter, referred to as simply “processor”) 1902, and at least one memory (hereinafter, referred to as simply “memory”) 1903. The transceiver 1901, the processor 1902, and the memory 1903 of the UE 1900 may operate to implement the methods described above. However, components of the UE 1900 are not limited to the components illustrated in FIG. 19. In another embodiment, the UE 1900 may further include additional components in addition to the above-mentioned components, or some components may be omitted. Further, any combination of the transceiver 1901, the processor 1902, or the memory 1903 may be integrated in the form of one component. Furthermore, the UE 1900 of FIG. 19 corresponds to a UE of the FIG. 6.

The transceiver 1901 may be a communication circuit or communication circuitry that enables the UE 1900 to perform wireless communication with a node or an entity of a network. For example, the transceiver 1901 may enable the UE 1900 to transmit or receive a signal to or from a BS through cellular communication, or to transmit or receive a signal to or from another UE through cellular communication. For example, the transceiver 1901 may support at least one of various cellular communication technologies including 3rd generation (3G), 4th generation (4G), long term evolution (LTE), 5th generation (5G) NR, 6th generation (6G), and various cellular wireless communication technologies supported by the transceiver (1901) may include all subsequent generations of evolved wireless communications.

The UE 1900 may include a plurality of transceivers. For example, in the case of supporting evolved-universal terrestrial radio access-new radio (E-UTRA-NR) dual connectivity (EN-DC), the UE 1900 may include a first transceiver supporting the 4G LTE wireless communication and a second transceiver supporting the 5G NR wireless communication. In the case of supporting NR-dual connectivity (NR-DC), the UE 1900 may include a plurality of transceivers supporting the 5G NR wireless communication. In the case of supporting near field wireless communication, the UE 1900 may separately include a transceiver supporting at least one standard in the group of wireless communication protocol standards as defined in the protocol standards for Bluetooth®, wireless local area network (WLAN) network (including institute of electrical and electronics engineers (IEEE) 802.11-2016 standard or its amendments, e.g., 802.11ah, 802.11ad, 802.11ay, 802.11ax, 802.11az, 802.11ba, and 802.11be, without being limited thereto).

The transceiver 1901 may include various circuit structures used to transmit or receive signals to or from a BS through a wireless channel. The signals may include control information and data. For example, the transceiver 1901 may include a radio frequency (RF) transmitter for up-converting and amplifying the frequency of a transmitted signal and an RF receiver for low-noise-amplifying a received signal and down-converting the frequency thereof. The transceiver 1901 may output a signal received through a wireless channel to the processor 1902 and may transmit, through a wireless channel, a signal output from the processor 1902.

The processor 1902 may control general operations of the UE 1900 according to embodiments of the disclosure. The processor 1902 may be implemented by one or more integrated circuit (or circuitry) (IC) chips and may execute various data processes. The processor 1902 may include at least one electric circuit, and may execute instructions (or a program, codes, data, etc.) stored in the memory 1903, individually, collectively or in any combination thereof. Further, the processor 1902 may include a single-core processor or multi-core processor, and may include a processor assembly including a plurality of processing circuits (circuitry) according to a specific implementation scheme.

The processor 1902 may be electrically, operatively, or communicatively coupled to the transceiver 1901 to control the transceiver 1901.

The processor 1902 may include at least one processor (or processing circuitry), and the at least one processor may perform the following operations individually, collectively or in any combination thereof. For example, the processor 1902 may include a communication processor (CP) configured to control communication operations and an application processor (AP) configured to control execution of an upper layer (for example, an application layer). In a specific embodiment, at least a part of the processor 1902 may be included in one chip and the other part of the processor 1902 may be included in another chip. Otherwise, at least one processor may be included in another component, for example, the transceiver 1901 or the memory 1903.

The processor 1902 may perform or control or cause an operation of the UE 1900 for executing at least one or a combination of methods according to embodiments of the disclosure. For example, the processor 1902 may control operations of the UE 1900 for processing a downlink signal received from a BS or generating and transmitting an uplink signal to a BS. To this end, the processor 1902 may execute a computer program, codes, or instructions stored in the memory 1903, so as to control other components of the UE 1900 to enable execution of various operations.

The memory 1903 corresponds to a hardware storage device capable of temporarily or permanently storing information and may include one or more storage media. For example, the memory 1903 may include a memory assembly including one or more storage media. For example, the one or more storage media may include permanent memory, such as a hard drive, flash memory, or read-only memory (ROM), semipermanent memory, such as random access memory (RAM), cache memory, or a combination thereof.

The memory 1903 may be electrically, operatively, or communicatively coupled to the processor 1902 and may be accessed by the processor 1902.

The memory 1903 may store a computer program, codes, or instructions executable by the processor 1902. According to an embodiment, a computer program, codes, or instructions executable by the processor 1902 may be either stored in a single memory device or separated and stored in two or more memory devices. By executing the instructions stored in the memory 1903, the processor 1902 may perform various functions according to an embodiment of the disclosure.

According to an embodiment of the disclosure, operations of the UE 1900 may be caused to be performed based on execution of instructions (or a computer program or codes) stored in the memory 1903 by at least one processor (or processing circuitry) configured to execute the same individually, collectively, or in any combination thereof, based on processing circuitry that is not configured to execute instructions, and/or based on components of processing circuitry that is not configured to execute instructions.

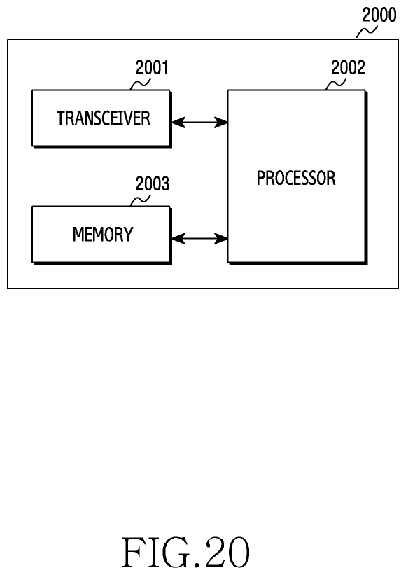

FIG. 20 is a block diagram of a base station (BS) 2000 according to an embodiment of the disclosure.

The BS 2000 may perform wireless communication with at least one user equipment (UE) located within the area of the BS 2000 through a wireless channel.

Referring to FIG. 20, the BS 2000 may include at least one transceiver (hereinafter, referred to as simply “transceiver”) 2001, at least one processor (hereinafter, referred to as simply “processor”) 2002, and at least one memory (hereinafter, referred to as simply “memory”) 2003. The transceiver 2001, the processor 2002, and the memory 2003 of the BS 2000 may operate the method described above. However, components of the BS 2000 are not limited to the components illustrated in FIG. 20. The BS 2000 may further include additional components in addition to the above-mentioned components, or some components may be omitted. Further, any combination of the transceiver 2001, the processor 2002, or the memory 2003 may be integrated in the form of one component. Furthermore, the BS 2000 of FIG. 20 corresponds to a BS of the FIG. 6.

The transceiver 2001 may be a communication circuit or communication circuitry that enables the BS 2000 to perform wireless communication with a node or an entity of a network. For example, the transceiver 2001 may enable the BS 2000 to transmit or receive a signal to or from the UE X00 through cellular communication, or to transmit or receive a signal to or from another network entity through wireless communication. For example, the transceiver 2001 may support various cellular communication technologies including 3rd generation (3G), 4th generation (4G), long term evolution (LTE), 5th generation (5G) NR, 6th generation (6G), and various cellular wireless communication technologies supported by the transceiver (2001) may include all subsequent generations of evolved wireless communications. The transceiver 2001 may include various circuit structures used to transmit or receive signals to or from a UE through a wireless channel. The signals may include control information and data. For example, the transceiver 2001 may include a radio frequency (RF) transmitter for up-converting and amplifying the frequency of a transmitted signal and an RF receiver for low-noise-amplifying a received signal and down-converting the frequency thereof. The transceiver 2001 may output a signal received through a wireless channel to the processor 2002 and may transmit, through a wireless channel, a signal output from the processor 2002. Furthermore, the transceiver 2001 may serve as the transmitting apparatus described in the disclosure.

The BS 2000 may communicate with a node or an entity of a network through wired or wireless communication. For example, the BS 2000 may perform wired or wireless communication with an adjacent BS, or a node or an entity of a core network through a backhaul network. Although not illustrated in FIG. 20, when the BS 2000 performs wired communication, the BS 2000 may further include a separate network interface for wired communication in addition to the transceiver 2001. The network interface may be referred to as network interface circuitry or communication interface circuitry.

The processor 2002 may control general operations of the BS 2000 according to embodiments of the disclosure. The processor 2002 may be implemented by one or more integrated circuit (or circuitry) (IC) chips and may execute various data processes. The processor 2002 may include at least one electric circuit, and may execute instructions (or a program, codes, data, etc.) stored in the memory 2003, individually, collectively or in any combination thereof. Further, the processor 2002 may include a single-core processor or multi-core processor, and may include a processor assembly including a plurality of processing circuits (circuitry) according to a specific implementation scheme.

The processor 2002 may be electrically, operatively, or communicatively coupled to the transceiver 2001 to control the transceiver 2001.

The processor 2002 may include at least one processor (or processing circuitry), and the at least one processor may perform the following operations individually, collectively or in any combination thereof. At least a part of the processor 2002 may be included in one chip and the other part of the processor 2002 may be included in another chip. Otherwise, at least one processor may be included in another component, for example, the transceiver 2001 or the memory 2003.

The processor 2002 may perform or control or cause an operation of the BS 2000 for executing at least one or a combination of methods according to embodiments of the disclosure. For example, the processor 2002 may control operations of the BS 2000 for generating and transmitting a downlink signal to a UE or processing an uplink signal received from a UE. Otherwise, the BS 2000 may transmit or receive a signal to or from a neighboring BS, transfer a signal received from a UE to an upper node of the network, or transmit a signal transferred from an upper node of the network to a UE. To this end, the processor 2002 may execute a computer program, codes, or instructions stored in the memory 2003, so as to control other components of the BS 2000 to enable execution of various operations.

The memory 2003 corresponds to a hardware storage device capable of temporarily or permanently storing information and may include one or more storage media. For example, the memory 2003 may include a memory assembly including one or more storage media. For example, the one or more storage media may include permanent memory, such as a hard drive, flash memory, or read-only memory (ROM), semipermanent memory, such as random access memory (RAM), cache memory, or a combination thereof.

The memory 2003 may be electrically, operatively, or communicatively coupled to the processor 2002 and may be accessed by the processor 2002.

The memory 2003 may store a computer program, codes, or instructions executable by the processor 2002. According to an embodiment, a computer program, codes, or instructions executable by the processor 2002 may be either stored in a single memory device or separated and stored in two or more memory devices. By executing the instructions stored in the memory 2003, the processor 2002 may perform various functions according to an embodiment of the disclosure.

Operations of the BS 2000 may be caused to be performed based on execution of instructions (or a computer program or codes) stored in the memory 2003 by at least one processor (or processing circuitry) configured to execute the same individually, collectively, or in any combination thereof, based on processing circuitry that is not configured to execute instructions, and/or based on components of processing circuitry that is not configured to execute instructions.

The UE or the base station may perform various communication procedures related to the control plane or the user plane by cooperating with one or more network entities based on wireless communication. For example, the UE may communicate with network entity such as an Access and Mobility Management Function (AMF) or a Session Management Function (SMF) via the base station, or the base station may perform at least one communication procedure by directly transmitting and receiving signals to/from, or relaying signals between, the network entities.

The structure of the above-described network entity will be described in more detail with reference to the drawings.

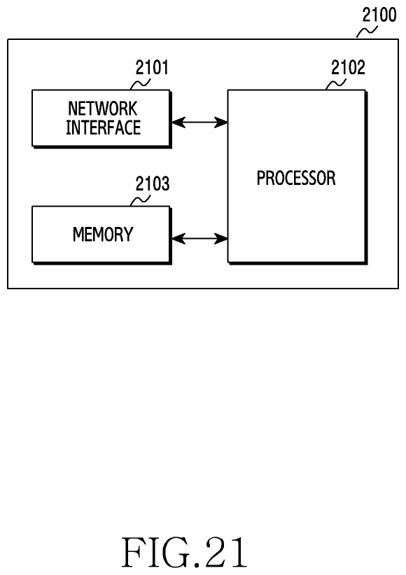

FIG. 21 is a block diagram of a network entity 2100 according to an embodiment of the disclosure.

Referring to FIG. 21, the network entity 2100 may include an entity (apparatus, device, or server, etc.) that performs one or more network functions (NFs) or a part of a network function constituting a core network (e.g., a 5th generation (5G) core (5GC)) in a communication system. In this case, multiple NFs may be implemented within a single network entity, or a single NF may be distributed and implemented across a plurality of network entities. In addition, when an NF is implemented within the network entity, the NF may be implemented in the form of software, and in such a case, a program for operating the NF may be stored in memory of the network entity 2100.

A single NF may be implemented by one or more instances, which may be deployed on the same network entity or distributed across multiple network entities to operate. The instance may be a software unit that logically executes a specific network function, and may be implemented in a form that is decoupled from physical hardware resources. Further, one or more NFs may be implemented in the form of one network slice to operate to satisfy specifications required by a particular service.

The NF may include at least one of an access and mobility management function (AMF), a session management function (SMF), a local session management function (L-SMF), a user plane function (UPF), a local user plane function (L-UPF), a policy control function (PCF), a unified data management (UDM), a unified data repository (UDR), a network exposure function (NEF), a network repository function (NRF), an application function (AF), a network slice selection function (NSSF), a network data analytics function (NWDAF), a network slice admission control function (NSACF), an authentication server function (AUSF), or a data network (DN).

Referring to FIG. 21, the network entity 2100 may include at least one network interface 2101, at least one processor 2102 (hereinafter, “processor”), and at least one memory 2103 (hereinafter, “memory”). As described above, a NF may be implemented in the form of a physical device such as the network entity 2100, or may be virtualized and executed in the form of an instance. When implemented as an instance, the NF need not necessarily include physical components as illustrated in FIG. 21. In such a case, the instance may be logically represented as comprising one or more logical functional elements. Furthermore, the network entity 2100 of FIG. 21 corresponds to a network entity of the core network of FIG. 6.

The network interface 2101, the processor 2102, and the memory 2103 of the network entity 2100 may operate to implement the methods described above. However, components of the network entity 2100 are not limited to the components illustrated in FIG. 21. The network entity 2100 may further include additional components in addition to the above-mentioned components, or some components may be omitted. Further, the network interface 2101, the processor 2102, or the memory 2103 may be integrated in the form of one component.

The network interface 2101 is a collective term for a transmitter part of the network entity 2100 and a receiver part of the network entity 2100, and may be a communication circuit for transmitting or receiving a signal to or from a user equipment (UE), a base station (BS), or another network entity. The communication circuit may include both a communication circuit for wireless communication and a communication circuit for a wired communication. For example, the network interface 2101 may include a circuit, logic, hardware, etc., configured to exchange a control plane message or a user plane message with a UE, a BS, or other core network entities through wireless communication or wired communication. The network interface 2101 may operate using various protocols (e.g., non-access stratum (NAS) protocol). The network interface 2101 may also be referred to, for convenience of description or depending on implementation, as communication circuitry, network interface circuitry, or communication interface circuitry.

The processor 2102 may control general operations of the network entity 2100 according to embodiments of the disclosure. The processor 2102 may be implemented by one or more integrated circuit (or circuitry) (IC) chips and may execute various data processes. The processor 2102 may include at least one electric circuit, and may execute instructions (or a program, codes, data, etc.) stored in the memory 2103, individually, collectively or in any combination thereof. Further, the processor 2102 may include a single-core processor or multi-core processor, and may include a processor assembly including a plurality of processing circuits (circuitry) according to a specific implementation scheme. In a case where NF is implemented in the form of an instance, the network function may be not necessarily configured by physical hardware.

The processor 2102 may be electrically, operatively, or communicatively coupled to the network interface 2101 to control the network interface 2101.

The processor 2102 may include at least one processor (or processing circuitry), and the at least one processor may perform the following operations individually, collectively or in any combination thereof. At least a part of the processor 2102 may be included in one chip and the other part of the processor 2102 may be included in another chip. Otherwise, at least one processor may be included in another component, for example, the network interface 2101 or the memory 2103.

The processor 2102 may perform or control or cause an operation of the network entity 2100 for executing at least one or a combination of methods according to embodiments of the disclosure. For example, the processor 2102 may control operations of the network entity 2100 for exchanging a control plane message or a user plane message with a UE, a BS, or other core network entities through wireless or wired communication, using various protocols (e.g., NAS protocol). To this end, the processor 2102 may execute a computer program, codes, or instructions stored in the memory 2103, so as to control other components of the network entity 2100 to enable execution of various operations.

The memory 2103 corresponds to a hardware storage device capable of temporarily or permanently storing information and may include one or more storage media. For example, the memory 2103 may include a memory assembly including one or more storage media. For example, the one or more storage media may include permanent memory, such as a hard drive, flash memory, or read-only memory (ROM), semipermanent memory, such as random access memory (RAM), cache memory, or a combination thereof.

The memory 2103 may be electrically, operatively, or communicatively coupled to the processor 2102 and may be accessed by the processor 2102.

The memory 2103 may store a computer program, codes, or instructions executable by the processor 2102. According to an embodiment, a computer program, codes, or instructions executable by the processor 2102 may be either stored in a single memory device or separated and stored in two or more memory devices. By executing the instructions stored in the memory 2103, the processor 2102 may perform various functions according to an embodiment of the disclosure.

Operations of the network entity 2100 may be caused to be performed based on execution of instructions (or a computer program or codes) stored in the memory 2103 by at least one processor (or processing circuitry) configured to execute the same individually, collectively, or in any combination thereof, based on processing circuitry that is not configured to execute instructions, and/or based on components of processing circuitry that is not configured to execute instructions.

As symbolically shown in the lower part of FIG. 15, the received CSI report can be used in the base station to take a decision, with respect to DL data transmission being scheduled (for example, PDSCH), regarding which mode to use for the scheduled transmission, namely the primary mode or some of the EE modes, as well as regarding which beamforming to use.

In view of the problems of the prior art discussed above, an object of the disclosure is to provide a reconfigurable subarray architecture (RSA) for a transmitting apparatus of a base station, which, on one hand, would support dynamic switching between the primary and EE mode(s) of the base station, and, on the other hand, in any EE mode, would allow keeping all antenna elements of an antenna array of the base station in the active (i.e. unmuted) state, thereby avoiding decrease in the antenna gain and associated negative effects.

In the context of addressing this technical object, according to the first aspect of the disclosure a transmitting apparatus of a base station is provided, the transmitting apparatus comprising: an antenna array comprised of antenna elements, wherein the antenna array is divided into subarrays. In a typical case, each subarray combines the same number of antenna elements. The transmitting apparatus comprises, for each subarray, a transmission chain, wherein the transmission chain, at an output, is coupled to the subarray, wherein each transmission chain comprises a power amplifier, wherein at least some power amplifiers in the transmitting apparatus are configured to be turned off in operation of the base station.

The transmitting apparatus provided herein comprises a system of commutators where each commutator is included in at least two transmission chains, wherein the inclusion in each of the at least two transmission chains is implemented by: a respective input of the commutator placed after an output of a power amplifier, and a respective output of the commutator. The commutator comprises a power divider subsystem comprising at least one power divider, wherein each power divider of the at least one power divider comprises: an input coupled to one of inputs of the commutator, and at least two outputs each coupled to one of outputs of the commutator, in such a way that the commutator is configured to, when signals from power amplifiers of one or more of the at least two transmission chains are provided to respective one or more inputs of the commutator and power amplifiers of the other of the at least two transmission chains are off: by means of the power divider subsystem, forward incoming signals from the respective one or more inputs of the commutator to the outputs of the commutator. The forwarding of incoming signals preferably comprises: by means of the power divider subsystem, distributing power of the incoming signals to all the outputs of the commutator. A transmission chain preferably further comprises: a digital-to-analog converter whose input is an input of the transmission chain and intended for being provided with a respective digital signal, and a band-pass filter placed after the system of commutators.

According to an embodiment, each commutator of the system of commutators further comprises: for each transmission chain of the at least two transmission chains in which the commutator is included, a pass-through line directly connecting a respective input of the commutator with a respective output of the commutator; and a switch subsystem comprising: an output switch at each output of the commutator, and an input switch, at least, at each input of the commutator whereto the power divider subsystem is coupled. The switch subsystem has: a pass-through state of switches wherein all pass-through lines are in a connected state and the power divider subsystem is in a disconnected state; and at least one distributing state of switches wherein the power divider subsystem is in a respective one connected state and pass-through lines are in a disconnected state.

In accordance with an embodiment, the system of commutators comprises one or more levels of commutators, wherein the levels of commutators sequentially follow each other, wherein inputs of each commutator of a subsequent level of commutators are coupled to outputs of commutators of a preceding level of commutators.

According to an embodiment, in each commutator the at least one power divider of the power divider subsystem of the commutator is one power divider, wherein outputs of the power divider are coupled to all outputs of the commutator, wherein the switch subsystem of the commutator has one distributing state of switches where the power divider is in the connected state and pass-through lines of the commutator are in the disconnected state. In accordance with an implementation of the one embodiment, each commutator is included in two neighboring transmission chains and configured to: when a power amplifier of one of the two transmission chains is on and a power amplifier of another of the two transmission chains is off, which refers to an energy efficient operation mode of the base station, forward, in the distributing state of switches of the switch subsystem, a signal from the power amplifier of the one transmission chain towards an output of each of the two transmission chains; and when the power amplifier of each of the two transmission chains is on, which refers to a primary operation mode of the base station, forward, in the pass-through state of switches of the switch subsystem, a signal from the power amplifier of the transmission chain towards its output.

According to another embodiment, the at least one power divider of the power divider subsystem of the commutator is two or more power dividers, wherein the two or more power dividers in the power divider subsystem are implemented in one or more power divider levels, wherein in each subsequent power divider level a number of power dividers is respectively less than a number of power dividers in a preceding power divider level, wherein a number of outputs of any power divider in each one of the two or more power divider levels of the power divider subsystem is identical, and outputs of power dividers of the power divider level are one-to-one coupled to all outputs of the commutator, wherein a number of outputs of a power divider in each subsequent power divider level is respectively greater than a number of outputs of a power divider in a preceding power divider level.

According to an embodiment, each commutator is included in four neighboring transmission chains, wherein the power divider subsystem of the commutator comprises two power divider levels, wherein a first power divider level comprises two power dividers, and a second power divider level comprises one power divider. The switch subsystem of the commutator has two distributing states of switches, where, in a first distributing state of switches of the two distributing states of switches, the power dividers of the first power divider level are in the connected state, while the power divider of the second power divider level is in the disconnected state, and, in a second distributing state of switches, the power divider of the second power divider level is in the connected state, and the power dividers of the first power divider level are in the disconnected state. The commutator is configured to: when a power amplifier of each of the four transmission chains is on, which refers to the primary operation mode of the base station, forward, in the pass-through state of switches of the switch subsystem, a signal from the power amplifier of the transmission chain towards its output; when power amplifiers of two transmission chains to which inputs of the commutator are coupled whereto the inputs of the power dividers of the first power divider level are coupled are on and power amplifiers of the other transmission chains are off, which refers to a first energy efficient operation mode of the base station, forward, in the first distributing state of switches of the switch subsystem, signals from the power amplifiers of the two transmission chains towards outputs of the four transmission chains; and when a power amplifier of one transmission chain to which an input of the commutator is coupled whereto the input of the power divider of the second power divider level is coupled is on and power amplifiers of the other transmission chains are off, which refers to a second energy efficient operation mode of the base station, forward, in the second distributing state of switches of the switch subsystem, a signal from the power amplifier of the one transmission chain towards the outputs of the four transmission chains.

According to an embodiment, each of at least some of the at least two transmission chains in which the commutator is included further comprises a phase shifter placed before an output of the transmission chain and configured to be set to a respective predefined value in order to provide a phase shift between signals transmitted from subarrays coupled to the at least two transmission chains. As an option, a phase shifter can be included in each transmission chain of the transmitting apparatus.

In accordance with an embodiment, digital signals provided to inputs of transmission chains can be CSI-RSs, wherein the base station is configured to: transmit CSI-RSs when all power amplifiers are on, or transmit CSI-RSs when some of the power amplifiers are on and some of the power amplifiers are off.

According to the disclosure, a transmitting apparatus of a base station is provided, the transmitting apparatus comprising an antenna array comprised of antenna elements, wherein the antenna array is divided into subarrays. The transmitting apparatus comprises, for each subarray, a transmission chain, wherein the transmission chain is connected, at its output, to the subarray, wherein each transmission chain comprises a power amplifier, wherein at least some of power amplifiers in the transmitting apparatus are configured to be turned off in operation of the base station. The transmitting apparatus comprises a system of commutators, wherein each commutator is included in at least two transmission chains, wherein the inclusion in each of the at least two transmission chains is implemented by a respective input of the commutator placed after an output of the power amplifier, and a respective output of the commutator. The commutator comprises a power divider subsystem comprising at least one power divider, wherein each power divider of the at least one power divider comprises: an input coupled to one of inputs of the commutator, and at least two outputs each coupled to one of outputs of the commutator, in such a way that the commutator is configured, when signals from power amplifiers of one or more of the at least two transmission chains are provided to respective one or more inputs of the commutator and power amplifiers of the other of the at least two transmission chains are off: by means of the power divider subsystem, to forward incoming signals from the respective one or more inputs of the commutator to the outputs of the commutator. According to the disclosure, a method of obtaining and transmitting CSI for using the RSA is also provided. The disclosure provides support for flexible dynamic switching between the primary and energy efficient mode(s) of the base station, while avoiding decrease in the antenna gain in any energy efficient mode, as well as reduction of load onto the network associated with requesting and reporting CSI for different base station operation modes.

According to the second aspect of the disclosure a base station is provided, the base station comprising a transmitting apparatus according to any of embodiments of the first aspect of the disclosure.

Another object of the disclosure is to provide a method of obtaining and transmitting CSI to use the RSA so that the method enables to reduce overhead associated with requesting and reporting the CSI for different operation modes of a base station.

In the context of addressing the technical object, according to the third aspect of the disclosure a method of obtaining CSI in a wireless communication system including a base station comprising a transmitting apparatus according to the first aspect of the disclosure. The method provided herein comprises: performing, from the base station, transmissions of CSI-RSs, wherein the CSI-RSs relate to two or more CSI-RS resource sets, where at least in two CSI-RS resource sets of the two or more CSI-RS resource sets a number of CSI-RS ports of a CSI-RS resource is different; transmitting, from the base station to a user equipment, a CSI request comprising at least an indication of two or more CSI-RS resources from different CSI-RS resource sets among the two or more CSI-RS resource sets; and obtaining, in the user equipment, CSI with respect to at least some of the two or more CSI-RS resources indicated by the indication in the received CSI request, wherein the CSI comprises respective parameters for each of the at least some CSI-RS resources. Said two or more CSI-RS resource sets are preferably predefined in the base station and signaled in advance from the base station to the user equipment via RRC signaling.

In accordance with an embodiment, the two or more CSI-RS resource sets comprise: one CSI-RS resource set comprising a CSI-RS resource corresponding to DL data transmission when all power amplifiers of the transmitting apparatus of the base station are in an on state; and at least one other CSI-RS resource set, wherein each j-th CSI-RS resource set of the at least one other CSI-RS resource set comprises Nᵣₛᵣ^{(j)} CSI-RS resources, where Nᵣₛᵣ^{(j)}≥1, wherein each CSI-RS resource set of the at least one other CSI-RS resource set corresponds to a different configuration of on and off states of the power amplifiers of the transmitting apparatus and/or states of switches of commutators of the transmitting apparatus during DL data transmission, the configuration respectively defining a number of CSI-RS ports of a CSI-RS resource in the CSI-RS resource set.

According to a preferred embodiment, for each commutator of the system of commutators of the transmitting apparatus of the base station, each of at least some of the at least two transmission chains in which the commutator is included further comprises a phase shifter placed before an output of the transmission chain and configured to be set to a respective predefined value in order to provide a phase shift between signals transmitted from subarrays coupled to the at least two transmission chains. For at least part of the at least one other CSI-RS resource set, Nᵣₛᵣ^{(j)} CSI-RS resources of a j-th CSI-RS resource set correspond to DL data transmission with beamforming with respective usage of phase shifters of the transmitting apparatus of the base station.

In accordance with an embodiment, the CSI request is transmitted via DCI, wherein the CSI request comprises a bit field, wherein the indication is represented by a value of the bit field accordingly selected by the base station from at least part of a combination of bit values, wherein the combination of bit values is predefined by the base station and signaled in advance from the base station to the user equipment via RRC signaling. According to an implementation of the embodiment, the value of the bit filed comprised in the CSI request indicates the CSI-RS resource of the one CSI-RS resource set and a respective target number of CSI-RS resources which are to be selected from a specific CSI-RS resource set of the at least one other CSI-RS resource set, wherein for a j-th CSI-RS resource set from the at least one other CSI-RS resource set the respective target number Kⱼ of CSI-RS resources is 1≤Kⱼ≤ᵣₛᵣ^{(j)}. Said selection of a target number of CSI-RS resources from a specific CSI-RS resource set can be performed in the user equipment based on measurement of received power of respective CSI-RSs or predicted values of spectral efficiency of respective downlink data transmissions. Moreover, the selection of CSI-RS resources can comprise: selecting, from the specific CSI-RS resource set, CSI-RS resources in amount less than the respective target number of CSI-RS resources.

In accordance with an embodiment, the method further comprises: reporting the obtained CSI from the user equipment to the base station, wherein the CSI is transmitted via UCI, wherein the CSI in UCI comprises CSI part 1 and CSI part 2, wherein a payload size of CSI part 1 is fixed, and a payload size of CSI part 2 is variable and dependent on contents of CSI part 1. Said respective parameters preferably include: for the CSI-RS resource of the one CSI-RS resource set, RI, CQI, and PMI accordingly calculated in the user equipment; for any CSI-RS resource from the at least one other CSI-RS resource set, a respective CRI, as well as RI, CQI, and PMI accordingly calculated in the user equipment, wherein PMI is represented in the CSI by two parameters: PMI1 and PMI2.

According to one implementation, the respective parameters include parameters relating to a WB report. CSI part 1 comprises: a set {RI₀, wCQI₀} for the CSI-RS resource of the one CSI-RS resource set, and, after the set {RI₀, wCQI₀}, a sequence of sets {CRIᵢ, RIᵢ, wCQIᵢ} for reported CSI-RS resources from the at least one other CSI-RS resource set, where 1≤i≤M−1, M≥2 is a number of the at least some CSI-RS resources about which the CSI is reported. CSI part 2 comprises: a set {wPMI1₀, wPMI2₀} for the CSI-RS resource of the one CSI-RS resource set, and, after the set {wPMI1₀, wPMI2₀}, a sequence of sets {wPMI1ᵢ, wPMI2ⱼ} for reported CSI-RS resources from the at least one other CSI-RS resource set, where 1≤i≤M−1. The sequence of sets {wPMI1ᵢ, wPMI2ᵢ} is ordered in CSI part 2 according to ordering of {CRIⱼ} in CSI part 1.

According to another implementation, the respective parameters further include parameters relating to a SB report. CSI part 1 comprises: a set {RI₀, wCQI₀, sCQI₀} for the CSI-RS resource of the one CSI-RS resource set, and, after the set {RI₀, wCQI₀, sCQI₀}, a sequence of sets {CRIᵢ, RIᵢ, wCQIᵢ, sCQIᵢ} for reported CSI-RS resources from the at least one other CSI-RS resource set, where 1≤i≤M−1, M≥2 is a number of the at least some CSI-RS resources about which the CSI is reported. CSI part 2 comprises: a first set {wPMI1ᵢ} followed by a second set {sPMI2ᵢ^{(e)}} followed by a third set {sPMI2ᵢ^{(o)}}, where 0≤i≥M−1, wherein: wPMI1₀, sPMI2₀^{(e)}, sPMI2₀^{(o)} are for the CSI-RS resource of the one CSI-RS resource set; {wPMI1ⱼ}, 1≤j≤M−1, following wPMI1₀ are for reported CSI-RS resources from the at least one other CSI-RS resource set, wherein {wPMI1ⱼ} are ordered in the first set according to ordering of {CRIⱼ} in CSI part 1; {sPMI2ⱼ^{(e)}}, 1≤j≤M−1, following sPMI2₀^{(e)} are for reported CSI-RS resources from the at least one other CSI-RS resource set, wherein {sPMI2ⱼ^{(e)}} are ordered in the second set according to the ordering of {CRIⱼ} in CSI part 1; and {sPMI2ⱼ^{(o)}}, 1≤j≤M−1, following sPMI2₀^{(o)} are for reported CSI-RS resources from the at least one other CSI-RS resource set, wherein {sPMI2ⱼ^{(o)}} are ordered in the third set according to the ordering of {CRIⱼ} in CSI part 1.

A technical effect achievable by the disclosure is in providing:
support for flexible dynamic switching between the primary and EE modes of the base station, while avoiding decrease in the antenna gain in any EE mode,
reduction of network overhead which is associated with requesting and reporting CSI for different operation modes of the base station.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A base station (BS) comprising:
an antenna array including a plurality of antenna elements (AEs), the antenna array being divided into a plurality of subarrays;
a plurality of transmission chains, each transmission chain being coupled to a corresponding subarray, and including a power amplifier, wherein at least two power amplifiers are configured to be turned off during operation of the base station; and
a system comprising a plurality of commutators, each commutator being coupled to at least two of the plurality of transmission chains, wherein each commutator comprises:
an input connected to an output of a corresponding power amplifier,
an output connected to an input of the corresponding subarray, and
a power divider subsystem including at least one power divider,
wherein each of the at least one power divider comprises:
an input coupled to an input of a commutator, and
at least two outputs coupled to at least two outputs of the commutator.

2. The BS of claim 1,
wherein the commutator is configured to:
forward a signal received at the input of the commutator to the at least one output of the commutator, and
distribute a power of the signal to the at least one output of the commutator.

3. The BS of claim 1,
wherein the commutator further comprises:
for the transmission chain of the at least two transmission chains to which the commutator is coupled, a pass-through line directly connecting a respective input of the commutator to a respective output of the commutator, and
a switch subsystem including:
an output switch at each output of the commutator, and
at least one input switch at each input of the commutator,
wherein the power divider subsystem comprises:
a pass-through state in which all pass-through lines are in a connected state, and the power divider subsystem is in a disconnected state, and
at least one distributing state in which the power divider subsystem is in the connected state, and pass-through lines are in the disconnected state.

4. The BS of claim 3,
wherein the system comprises one or more levels of commutators,
wherein the levels of commutators sequentially follow each other according to the levels, and
wherein inputs of a subsequent level of commutators are coupled to outputs of a preceding level of commutators.

5. The BS of claim 3,
wherein, in the commutator, the at least one power divider is one power divider,
wherein outputs of the one power divider are coupled to all outputs of the commutator, and
wherein the switch subsystem of the commutator has one distributing state of switches where the one power divider is in the connected state and pass-through lines of the commutator are in the disconnected state.

6. The BS of claim 5,
wherein the commutator is coupled to two neighboring transmission chains and configured to:
in case that a first power amplifier of a first transmission chain among the two neighboring transmission chains is on and a second power amplifier of a second transmission chain among the two transmission chains is off, forward, in the distributing state of switches of the switch subsystem, a signal received from the power amplifier towards an output of each of the two neighboring transmission chains; and
in case that the first and the second power amplifier are on, forward, in the pass-through state of switches of the switch subsystem, the signal received from the power amplifier towards output of the commutator.

7. The BS of claim 3,
wherein the at least one power divider comprises a plurality of power dividers,
wherein the plurality of power dividers are implemented by two or more power divider levels,
wherein a first number of power dividers in a subsequent power divider level is less than a second number of power dividers in a preceding power divider level,
wherein a third number of outputs in the subsequent power divider level and a fourth number of outputs in the preceding power divider level are identical, and outputs of the plurality of power dividers are one-to-one coupled to all outputs of the commutator, and
wherein the third number of outputs in the subsequent power divider level is greater than a fifth number of outputs of each power divider in the preceding power divider level.

8. The BS of claim 7,
wherein the commutator is coupled to four neighboring transmission chains,
wherein the power divider subsystem comprises two power divider levels including a first power divider level and a second power divider level,
wherein the first power divider level comprises two power dividers, and the second power divider level comprises one power divider,
wherein the switch subsystem has two distributing states of switches,
wherein, in a first distributing state of switches, the power dividers of the first power divider level are in the connected state, while the power divider of the second power divider level is in the disconnected state, and
wherein, in a second distributing state of switches, the power divider of the second power divider level is in the connected state, and the power dividers of the first power divider level are in the disconnected state.

9. The BS of claim 8,
wherein the commutator is configured to:
in case that a power amplifier of each of the four neighboring transmission chains is on, forward, in the pass-through state of switches, a signal received from the power amplifier towards outputs of the commutator,
in cast that two power amplifiers corresponding to the first power divider level are on, and the other power amplifiers are off, forward, in the first distributing state of switches of the switch subsystem, signals received from the two power amplifiers towards four outputs of the four transmission chains, and
in case that one power amplifier corresponding to the second power divider level is on, and the other power amplifiers are off, forward, in the second distributing state of switches of the switch subsystem, a signal from the one power amplifier towards the four outputs of the four transmission chains.

10. The BS of claim 1,
wherein the each transmission chain further includes a phase shifter placed before an output of the each transmission chain.

11. The BS of claim 10,
wherein the phase shifter is set to a predefined value in order to provide a phase shift between signals transmitted from subarrays coupled to the at least two transmission chains.

12. The BS of claim 1,
wherein the each transmission chain further includes:
a digital-to-analog converter whose input is an input of the transmission chain and intended for being provided with a respective digital signal, and
a band-pass filter placed after the system of commutators, and
wherein each subarray includes an identical number of AEs.

13. The BS of claim 12,
wherein digital signals provided to inputs of transmission chains are channel state information reference signals (CSI-RSs), and
wherein the BS is configured to:
transmit CSI-RSs while all power amplifiers are on, or
transmit CSI-RSs while some of the all power amplifiers are on and the at least two of the power amplifiers are off.

14. A method performed by a base station (BS) in a wireless communication system, the method comprising:
transmitting, to a user equipment (UE), channel state information (CSI) reference signals (CSI-RSs), wherein the CSI-RSs relate to two or more CSI-RS resource sets, where at least two CSI-RS resource sets of the two or more CSI-RS resource sets have a different a number of CSI-RS ports of a CSI-RS resource;
transmitting, to the UE, a CSI request, the CSI request comprising at least an indication of two or more CSI-RS resources from different CSI-RS resource sets among the two or more CSI-RS resource sets; and
receiving, from the UE, CSI with respect to at least two of the two or more CSI-RS resources indicated by the indication in the CSI request, the CSI comprising respective parameters for each of the at least two CSI-RS resources.

15. The method of claim 14, wherein the two or more CSI-RS resource sets are predefined in the base station and signaled in advance from the base station to the user equipment via radio resource control (RRC) signaling.

16. The method of claim 14,
wherein the two or more CSI-RS resource sets comprise:
one CSI-RS resource set comprising a CSI-RS resource corresponding to downlink (DL) data transmission when all power amplifiers of the base station are in an on state, and
at least one other CSI-RS resource set,
wherein each j-th CSI-RS resource set of the at least one other CSI-RS resource set comprises Nᵣₛᵣ^{(j)} CSI-RS resources, where Nᵣₛᵣ^{(j)}≥1, and
wherein each CSI-RS resource set of the at least one other CSI-RS resource set corresponds to a different configuration of on and off states of the power amplifiers and/or states of switches of commutators of the BS during DL data transmission, the configuration respectively defining a number of CSI-RS ports of a CSI-RS resource in the CSI-RS resource set.

17. The method of claim 16,
wherein, for each commutator of the system of commutators of the BS, each of at least two transmission chains in which the commutator is included further comprises a phase shifter placed before an output of the transmission chain and configured to be set to a respective predefined value in order to provide a phase shift between signals transmitted from subarrays coupled to the at least two transmission chains, and
wherein, for at least part of the at least one other CSI-RS resource set, Nᵣₛᵣ^{(j)} CSI-RS resources of a j-th CSI-RS resource set correspond to DL data transmission with beamforming (BF) with respective usage of phase shifters of the BS.

18. The method of claim 16,
wherein the CSI request is transmitted via downlink control information (DCI),
wherein the CSI request comprises a bit field,
wherein the indication is represented by a value of the bit field accordingly selected by the base station from at least part of a combination of bit values, and
wherein the combination of bit values is predefined and signaled in advance to the user equipment via RRC signaling.

19. The method of claim 18,
wherein the value of the bit filed included in the CSI request indicates the CSI-RS resource of the one CSI-RS resource set and a respective target number of CSI-RS resources which are to be selected from a specific CSI-RS resource set of the at least one other CSI-RS resource set, and
wherein for a j-th CSI-RS resource set from the at least one other CSI-RS resource set the respective target number Kⱼ of CSI-RS resources is 1≤K≤Nᵣₛᵣ^{(j)}.

20. A method performed by a user equipment (UE) in a wireless communication system, the method comprising:
receiving, from a base station (BS), channel state information (CSI) reference signals (CSI-RSs), wherein the CSI-RSs relate to two or more CSI-RS resource sets, where at least in two CSI-RS resource sets of the two or more CSI-RS resource sets a number of CSI-RS ports of a CSI-RS resource are different;
receiving, from the BS, a CSI request, the CSI request comprising at least an indication of two or more CSI-RS resources from different CSI-RS resource sets among the two or more CSI-RS resource sets; and
obtaining CSI with respect to at least two of the two or more CSI-RS resources indicated by the indication in the received CSI request, wherein the CSI comprises respective parameters for each of the at least two CSI-RS resources; and
transmitting, to the BS, the CSI.
